(19) United States
(12) Patent Application Publication
(10) Pub. No.: US 2023/0353301 A1
(43) Pub. Date: Nov. 2, 2023

(54) PDCCH ON CRS SYMBOLS

(71) Applicant: QUALCOMM Incorporated, San Diego, CA (US)

(72) Inventors: Kazuki TAKEDA, Tokyo (JP); Peter GAAL, San Diego, CA (US); Mostafa KHOSHNEVISAN, San Diego, CA (US)

(21) Appl. No.: 17/661,265

(22) Filed: Apr. 28, 2022

(51) Int. Cl. H04L 5/00; H04L 25/02; H04W 72/04

(52) U.S. Cl. CPC H04L 5/0048; H04L 25/0224; H04W 72/042

(57) ABSTRACT

Apparatus, methods, and computer program products for wireless communication are provided. An example method may include receiving a radio resource control (RRC) communication from a second network node, where the RRC communication configures a set of cell-specific reference signal (CRS) resource elements (REs). The method may further include receiving a demodulation reference signal (DM-RS) configuration from the second network node, the DM-RS configuration configures a set of DM-RS REs associated with a PDCCH. A first subset of DM-RS REs in the set of DM-RS REs may overlap with the set of CRS REs in a time domain and a frequency domain. The method may further include communicating with the second network node based on one or more DM-RS REs in the set of DM-RS REs associated with the PDCCH, where the first subset of DM-RS REs is excluded from the one or more DM-RS REs.

### TECHNICAL FIELD

The present disclosure relates generally to communication systems, and more particularly, to wireless communication systems with cell-specific reference signal (CRS) resource elements (REs) and demodulation reference signal (DM-RS).

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus at a first network node are provided. The apparatus may include a memory and at least one processor coupled to the memory. The memory and the at least one processor coupled to the memory may be configured to receive a radio resource control (RRC) communication from a second network node, where the RRC communication configures a set of cell-specific reference signal (CRS) resource elements (REs). The memory and the at least one processor coupled to the memory may be further configured to receive a demodulation reference signal (DM-RS) configuration from the second network node, where the DM-RS configuration configures a set of DM-RS REs associated with a physical downlink control channel (PDCCH). A first subset of DM-RS REs in the set of DM-RS REs may overlap with the set of CRS REs in a time domain and a frequency domain. The memory and the at least one processor coupled to the memory may be further configured to communicate with the second network node based on one or more DM-RS REs in the set of DM-RS REs associated with the PDCCH, where the first subset of DM-RS REs is excluded from the one or more DM-RS REs.

In another aspect of the disclosure, a method, a computer-readable medium, and an apparatus at a first network node are provided. The apparatus may include a memory and at least one processor coupled to the memory. The memory and the at least one processor coupled to the memory may be configured to transmit a RRC communication for a second network node, where the RRC communication configures a set of CRS REs. The memory and the at least one processor coupled to the memory may be further configured to transmit a DM-RS configuration for the second network node, where the DM-RS configuration configures a set of DM-RS REs associated with a PDCCH, and where a first subset of DM-RS REs in the set of DM-RS REs overlaps with the set of CRS REs in a time domain and a frequency domain. The memory and the at least one processor coupled to the memory may be further configured to puncture or rate match the first subset of DM-RS REs. The memory and the at least one processor coupled to the memory may be further configured to communicate with the second network node based on one or more DM-RS REs of the set of DM-RS REs associated with the PDCCH, where the one or more DM-RS REs exclude the punctured or rate matched first subset of DM-RS REs.

To the accomplishment of the foregoing and related ends, the one or more aspects comprise the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating example overlap of RE for PDCCH candidate and CRS REs.

FIG. 5 is a diagram illustrating example communications between two network nodes.

FIG. 6 is a diagram illustrating examples where DM-RS REs that collide with CRS REs are excluded (e.g., punctured or rate matched).

FIG. 7 is a diagram illustrating examples where DM-RS REs that collide with CRS REs are excluded (e.g., punctured or rate matched).

FIG. 8 is a diagram illustrating examples where DM-RS REs that collide with CRS REs are excluded (e.g., punctured or rate matched) and non-excluded DM-RS REs on CRS symbols (DM-RS REs that overlap with CRS REs in the time domain) may be replaced by PDCCH REs.

FIG. 9 is a diagram illustrating examples where DM-RS REs that collide with CRS REs are excluded (e.g., punctured or rate matched) and non-excluded DM-RS REs on CRS symbols (DM-RS REs that overlap with CRS REs in the time domain) may be replaced by PDCCH REs.

FIG. 10 is a diagram illustrating example 1-symbol CORESET and CORESET of two or more symbols.

FIG. 11 is a diagram illustrating example precoder granularity for CORESET of two or more symbols.

FIG. 12 is a diagram illustrating resource element group (REG) bundle and associated DM-RS being outside the REG bundle.

FIG. 13 is a diagram illustrating resource element group (REG) bundle and associated DM-RS.

FIG. 14 is a diagram illustrating example CORESETs.

FIG. 15 is a diagram illustrating example CORESETs.

FIG. 16 is a diagram illustrating example CORESETs.

FIG. 17 is a flowchart of a method of wireless communication.

FIG. 18 is a flowchart of a method of wireless communication.

FIG. 19 is a flowchart of a method of wireless communication.

FIG. 20 is a diagram illustrating an example of a hardware implementation for an example apparatus and/or network entity.

FIG. 21 is a diagram illustrating an example of a hardware implementation for an example network entity.

FIG. 22 is a diagram illustrating an example of a hardware implementation for an example network entity.

### DETAILED DESCRIPTION

Aspects provided herein may enable more efficient usage of resources so that PDCCH may be present on OFDM symbols where CRS RE(s) are present and enable DM-RS REs to be excluded (e.g., punctured or rate matched) with relatively smaller degradation on channel estimation performance. The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

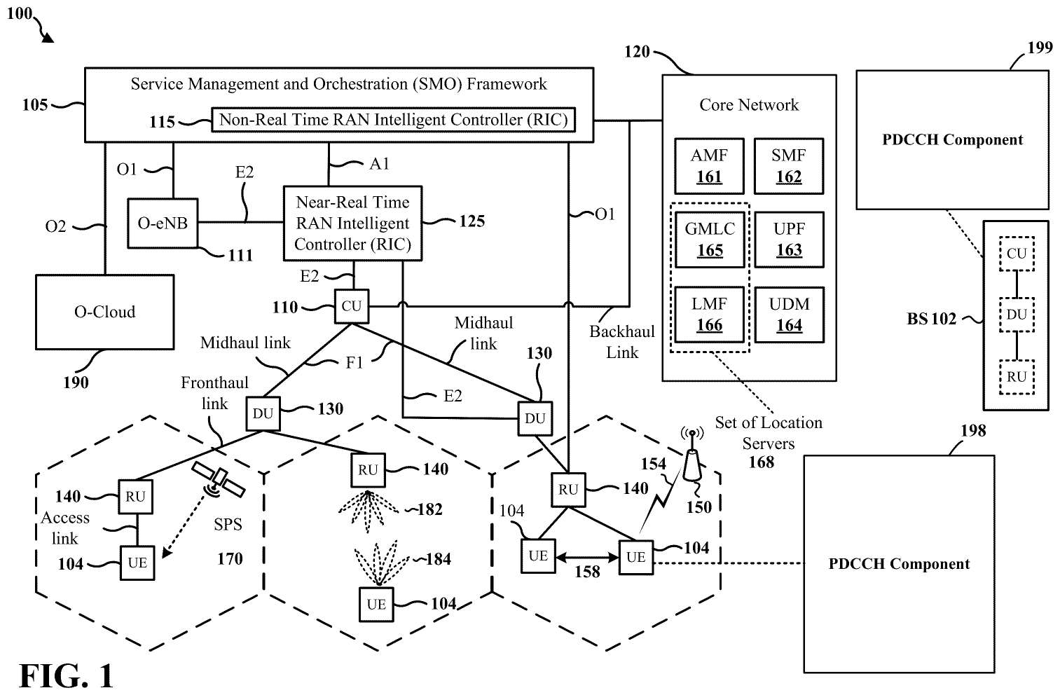

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUs 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via O1) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base stations 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth, Wi-Fi based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a transmit reception point (TRP), network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the serving base station 102. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in some aspects, the UE 104 may include a PDCCH component 198. In some aspects, the PDCCH component 198 may be configured to receive a radio resource control (RRC) communication from a second network node, where the RRC communication configures a set of cell-specific reference signal (CRS) resource elements (REs). In some aspects, the PDCCH component 198 may be further configured to receive a demodulation reference signal (DM-RS) configuration from the second network node, where the DM-RS configuration configures a set of DM-RS REs associated with a physical downlink control channel (PDCCH), and where a first subset of DM-RS REs in the set of DM-RS REs overlaps with the set of CRS REs in a time domain and a frequency domain. In some aspects, the PDCCH component 198 may be further configured to communicate with the second network node based on one or more DM-RS REs in the set of DM-RS REs associated with the PDCCH, where the first subset of DM-RS REs is excluded from (e.g., by puncturing or rate matching) the one or more DM-RS REs.

In certain aspects, the base station 102 may include a PDCCH component 199. In some aspects, the PDCCH component 199 may be configured to transmit a RRC communication for a second network node, where the RRC communication configures a set of CRS REs. In some aspects, the PDCCH component 199 may be further configured to transmit a DM-RS configuration for the second network node, where the DM-RS configuration configures a set of DM-RS REs associated with a PDCCH, and where a first subset of DM-RS REs in the set of DM-RS REs overlaps with the set of CRS REs in a time domain and a frequency domain. In some aspects, the PDCCH component 199 may be further configured to puncture or rate match the first subset of DM-RS REs. In some aspects, the PDCCH component 199 may be further configured to communicate with the second network node based on one or more DM-RS REs of the set of DM-RS REs associated with the PDCCH, where the one or more DM-RS REs exclude the punctured or rate matched first subset of DM-RS REs.

Although the following description may be focused on 5G NR, the concepts described herein may be applicable to other similar areas, such as LTE, LTE-A, CDMA, GSM, and other wireless technologies.

As described herein, a node (which may be referred to as a node, a network node, a network entity, or a wireless node) may include, be, or be included in (e.g., be a component of) a base station (e.g., any base station described herein), a UE (e.g., any UE described herein), a network controller, an apparatus, a device, a computing system, an integrated access and backhauling (IAB) node, a distributed unit (DU), a central unit (CU), a remote unit (RU), and/or another processing entity configured to perform any of the techniques described herein. For example, a network node may be a UE. As another example, a network node may be a base station or network entity. As another example, a first network node may be configured to communicate with a second network node or a third network node. In one aspect of this example, the first network node may be a UE, the second network node may be a base station, and the third network node may be a UE. In another aspect of this example, the first network node may be a UE, the second network node may be a base station, and the third network node may be a base station. In yet other aspects of this example, the first, second, and third network nodes may be different relative to these examples. Similarly, reference to a UE, base station, apparatus, device, computing system, or the like may include disclosure of the UE, base station, apparatus, device, computing system, or the like being a network node. For example, disclosure that a UE is configured to receive information from a base station also discloses that a first network node is configured to receive information from a second network node. Consistent with this disclosure, once a specific example is broadened in accordance with this disclosure (e.g., a UE is configured to receive information from a base station also discloses that a first network node is configured to receive information from a second network node), the broader example of the narrower example may be interpreted in the reverse, but in a broad open-ended way. In the example above where a UE is configured to receive information from a base station also discloses that a first network node is configured to receive information from a second network node, the first network node may refer to a first UE, a first base station, a first apparatus, a first device, a first computing system, a first set of one or more one or more components, a first processing entity, or the like configured to receive the information; and the second network node may refer to a second UE, a second base station, a second apparatus, a second device, a second computing system, a second set of one or more components, a second processing entity, or the like.

As described herein, communication of information (e.g., any information, signal, or the like) may be described in various aspects using different terminology. Disclosure of one communication term includes disclosure of other communication terms. For example, a first network node may be described as being configured to transmit information to a second network node. In this example and consistent with this disclosure, disclosure that the first network node is configured to transmit information to the second network node includes disclosure that the first network node is configured to provide, send, output, communicate, or transmit information to the second network node. Similarly, in this example and consistent with this disclosure, disclosure that the first network node is configured to transmit information to the second network node includes disclosure that the second network node is configured to receive, obtain, or decode the information that is provided, sent, output, communicated, or transmitted by the first network node.

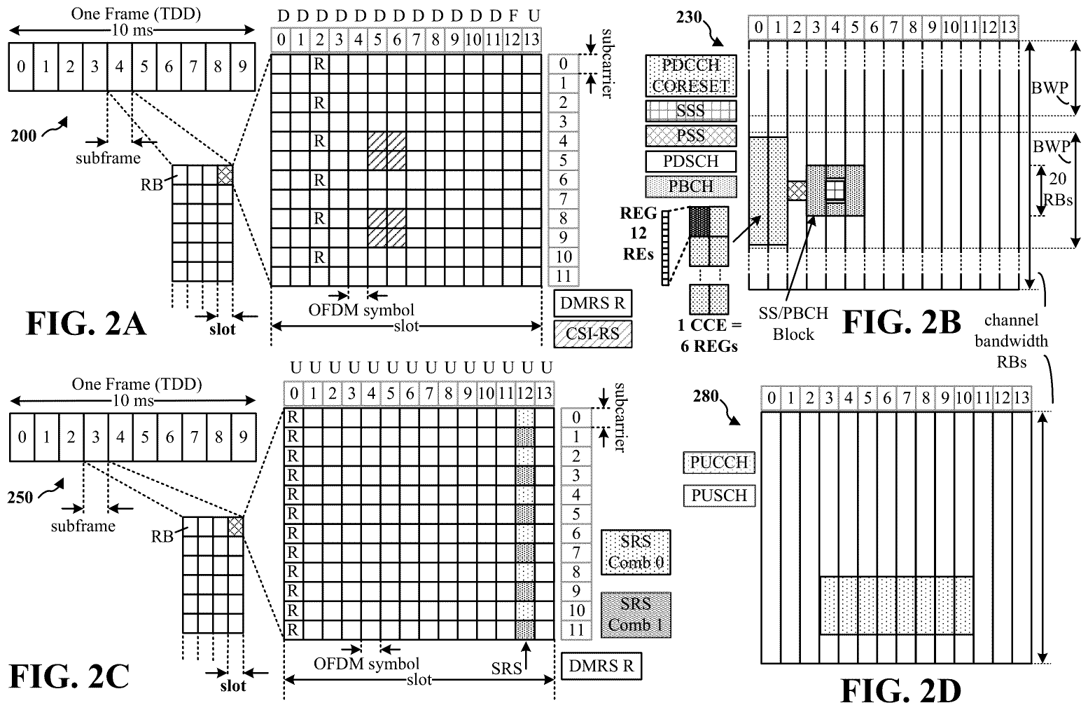

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI).

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the CP and the numerology. The numerology defines the subcarrier spacing (SCS) and, effectively, the symbol length/duration, which is equal to 1/SCS.

| | SCS | Cyclic |
|---|---|---|
| μ | Δƒ^{μ} = 2^{μ} · 15[kHz] | prefix |
| 0 | 15 | Normal |
| 1 | 30 | Normal |
| 2 | 60 | Normal, |
| | | Extended |
| 3 | 120 | Normal |
| 4 | 240 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame.

The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

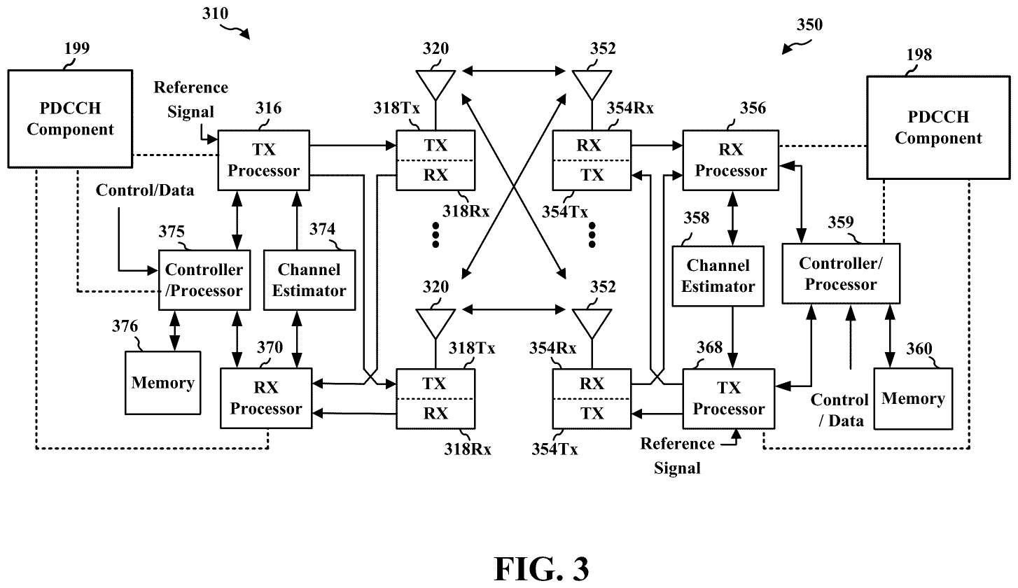

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching/puncturing, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the PDCCH component 198 of FIG. 1.

At least one of the TX processor 316, the RX processor 370, and the controller/processor 375 may be configured to perform aspects in connection with the PDCCH component 199 of FIG. 1.

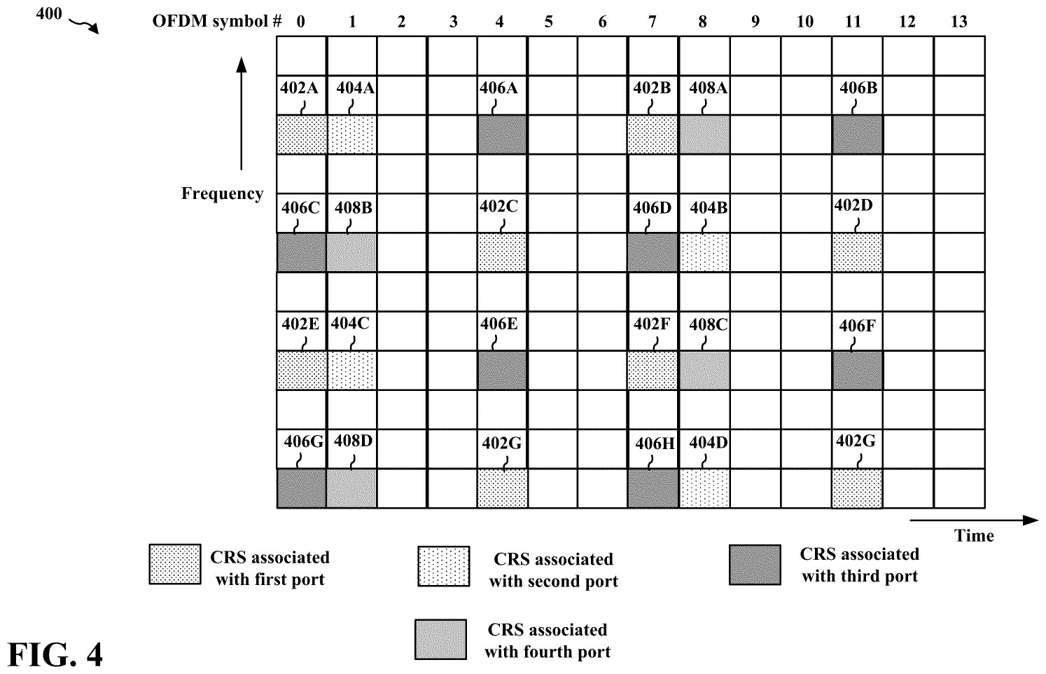

In some wireless communication systems, CRS (e.g., LTE CRS) may be transmitted for some UEs to perform cell search and initial acquisition, downlink channel quality measurements, or downlink channel estimation for coherent demodulation/detection at the UE. In these wireless communication systems, PDCCH (e.g., NR PDCCH) may also be transmitted for some UEs. In such wireless communication systems, multi-radio access technology (multi-RAT) may coexist, where each of the RATs share a same set of resources (e.g., time domain and frequency domain resources). Further, dynamic spectrum sharing (DSS) may be present to enable the sharing of resources between the RATs. In some situations, RE(s) of a PDCCH candidate for a UE on the serving cell may overlap with RE(s) of a CRS. In some wireless communication systems, a UE may not monitor PDCCH candidates that may overlap with RE(s) of a CRS, and a PDCCH may not span symbols that may overlap with RE(s) of a CRS. For example, FIG. 4 is a diagram 400 illustrating example overlap of RE for a PDCCH candidate and CRS REs. In FIG. 4, each grid may represent an OFDM symbol. As one example, a PDCCH candidate may span 1-3 OFDM symbol(s) of a slot depending on the parameters configured for the search space (such as a SearchSpace parameter) and the associated control resource set (CORESET) associated with the search space. As illustrated in FIG. 4, on a downlink cell, CRS symbols may be associated with different ports (e.g., downlink antenna ports), such as a first port, a second port, a third port, or a fourth port. As illustrated in FIG. 4, CRS REs 402A, 402B, 402C, 402D, 402E, 402F, and 402G may be associated with a first port (such as port #0). The CRS REs 404A, 404B, 404C, and 404D may be associated with a second port (such as port #1). The CRS REs 406A, 406B, 406C, 406D, 406E, 406F, 406G, and 406H may be associated with a third port (such as port #2). The CRS REs 408A, 408B, 408C, and 408D may be associated with a fourth port (such as port #3). As illustrated in FIG. 4, the CRS REs may be on OFDM symbols #0-#1, #4 , #7-8, #11. Because a UE may not monitor PDCCH candidates that overlap with RE(s) configured as CRS (e.g., LTE CRS that may not be monitored by some UEs, such as NR UEs), and a PDCCH may not span symbols that overlap with RE(s) of CRS, for DSS operations, a PDCCH may span one or multiple consecutive OFDM symbols from #2-#3, #5-#6, #9-#10, #12-#13, but not other OFDM symbols (e.g., OFDM symbols #0-#1, #4 , #7-8, #11). For PDCCH reception, based on aspects provided herein, PDCCH REs may be excluded (e.g., punctured or rate matched) based on CRS REs. The PDCCH REs may include information bits that are conveyed in different PDCCH REs. In addition, aspects provided herein may enable more efficient usage of resources so that PDCCH may be present on OFDM symbols where CRS RE(s) are present and enable DM-RS REs to be excluded (e.g., punctured or rate matched) with relatively smaller degradation on channel estimation performance. For example, DM-RS REs that overlap with CRS REs in the time domain and the frequency domain (which may be otherwise referred to as “collide with”) may be excluded (e.g., punctured or rate matched) (i.e., DM-RS is not transmitted on the REs). In some aspects, non-excluded (e.g., non-punctured or non-rate matched) DM-RS REs on CRS symbols (e.g., overlap with CRS REs in the time domain) may be replaced by PDCCH REs to enable more efficient usage of resources. In some aspects, DM-RS REs may be RE (e.g., smallest unit of the resource grid made up of one subcarrier in frequency domain and one OFDM symbol) that are used for carrying DM-RS. In some aspects, CRS REs may be RE (e.g., smallest unit of the resource grid made up of one subcarrier in frequency domain and one OFDM symbol) that are used for carrying CRS.

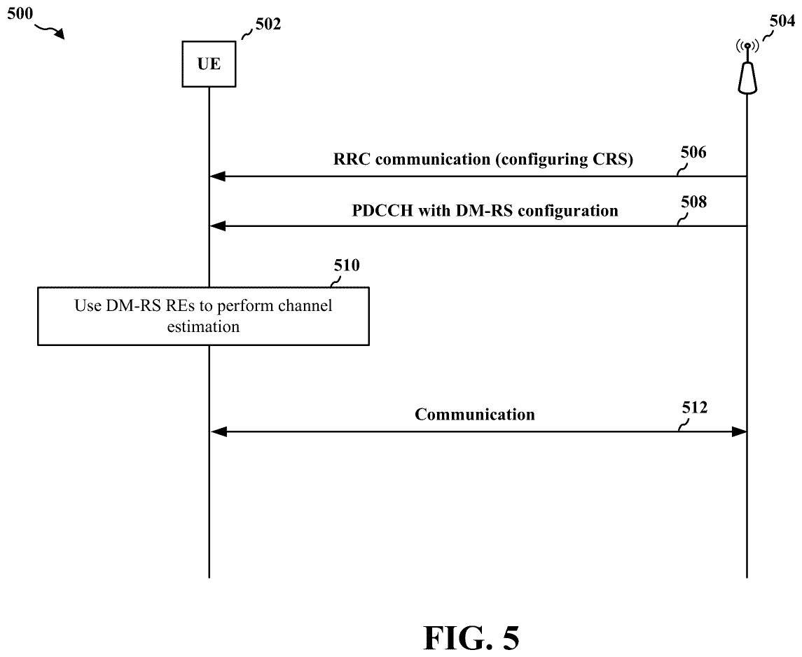

FIG. 5 is a diagram 500 illustrating example communications between network node 502 and network node 504. In some aspects, the network node 502 may be a UE. In some aspects, the network node 504 may be implemented as an aggregated base station, a disaggregated base station, an integrated access and backhaul (IAB) node, a relay node, a sidelink node, or the like. In some aspects, the network node 504 may be a network entity that may be implemented in an aggregated or monolithic base station architecture, or alternatively, in a disaggregated base station architecture, and may include one or more of a CU, a DU, a RU, a Near-Real Time (Near-RT) RAN Intelligent Controller (RIC), or a Non-Real Time (Non-RT) RIC.

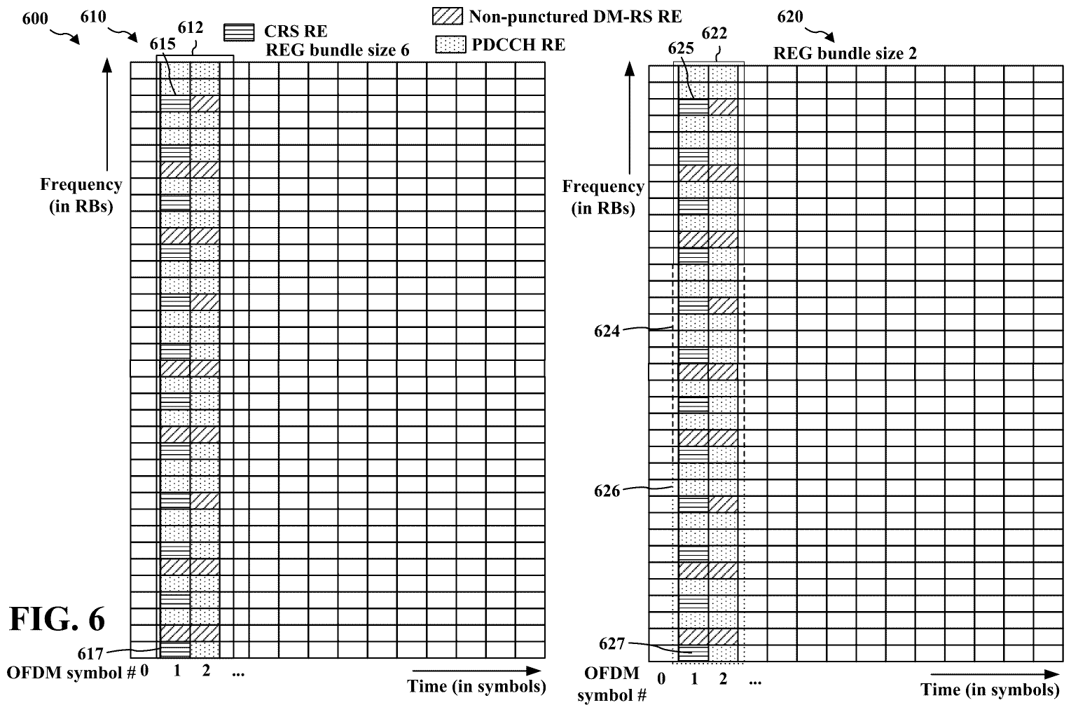

As illustrated in FIG. 5, the network node 502 may receive an RRC communication 506 from the network node 504, the RRC communication 506 may configure a set of CRS REs for the network node 502. In some aspects, the network node 502 may also receive PDCCH 508 with DM-RS configuration configuring a set of DM-RS REs from the network node 504. Details regarding the CRS REs configured by the RRC communication 506 and the PDCCH 508 are elaborated in more detail in connection with FIGS. 6-14. The network node 502 may use the configured DM-RS REs to perform channel estimations at 510 and transmit the channel estimation to the network node 504 (e.g., in a communication 512). The network node 502 and the network node 504 may also exchange other communications in the communication 512 based on the PDCCH 508 or the RRC communication 506.

FIG. 6 is a diagram 600 illustrating example 610 and example 620 where DM-RS REs that collide with CRS REs are excluded (e.g., punctured or rate matched). For example, DM-RS REs configured by the PDCCH 508 may collide with CRS REs configured by the RRC communication 506. The RRC communication may be for indicating CRS RE in a NR communication system. The DM-RS REs configured by the PDCCH 508 may be accordingly excluded (e.g., punctured or rate matched). As illustrated in FIG. 6, DM-RS REs that collide with CRS REs may be excluded (e.g., punctured or rate matched).

In some aspects, REs may be arranged in RE group (REG) bundles of a REG bundle size. One REG bundle may include one or more consecutive REGs and the bundle size may be based on an RRC parameter (such as L). For example, in example 610, the REG bundle size of the REG bundle 612 may be six (e.g., based on 3 RBs×2 symbols=6 REGs per REG bundle). In example 620, the REG bundle size of the REG bundle 622, the REG bundle 624, and the REG bundle 626 may be two (e.g., 1 RB×2 symbols=2 REGs per REG bundle). A REG bundle size may be based on a precoder granularity that a base station (e.g., the network node 504) may use for a UE (e.g., the network node 502). In some examples, each precoder may be associated with a different beam or precoding. In some aspects, REs in a same REG bundle may be associated with a same precoding. For example, the network node 504 may apply a same precoder for REs in the REG bundle 612. Similarly, the network node 504 may apply a first precoder for REs in the REG bundle 622, a second precoder for REs in the REG bundle 624, and a third precoder for REs in the REG bundle 626. When the network node 502 performs the channel estimation at 510, the network node 502 may average or filter channel estimation (e.g., to obtain a more accurate channel estimation) based on DM-RSs in a same REG bundle because a same precoder is associated with the REG bundle. In some aspects, the channel estimation at 510 may be DM-RS based channel estimations used for removing effects that may be applied on transmitted data to reduce error. For example, the network node 502 may perform channel estimation based on DM-RSs in the REG bundle 612 and average the channel estimations. The network node 502 may also perform channel estimation based on DM-RSs in the REG bundle 622 and average the channel estimations. The network node 502 may not average a first channel estimation based on DM-RSs in the REG bundle 622 and a second channel estimation based on DM-RSs in the REG bundle 624. Similarly, the network node 502 may not average a second channel estimation based on DM-RSs in the REG bundle 624 and a third channel estimation based on DM-RSs in the REG bundle 626.

In some aspects, each DM-RS in the REG bundle 612 and REG bundle 622 may be configured to be in pairs in the frequency domain (e.g., two DM-RSs on different symbols in a same RB) but some DM-RS REs may collide with CRS REs and may be accordingly excluded (punctured or rate matched). For example, a DM-RS RE that collides with the CRS RE 615 may be excluded (e.g., punctured or rate matched) and a DM-RS RE that collides with the CRS RE 625 may be excluded (punctured or rate matched). In some aspects, PDCCH REs that collide with CRS REs may also be excluded (e.g., punctured or rate matched). For example, a PDCCH RE may collide with CRS RE 617 and may be excluded (punctured or rate matched). A PDCCH RE may collide with CRS RE 627 and may be excluded (punctured or rate matched).

In some aspects, the network node 502 may use non-excluded (e.g., non-punctured or non-rate matched) DM-RS REs on CRS symbols (DM-RS REs that overlap with CRS REs in the time domain). In such aspects, the network node 502 may use all of the illustrated non-excluded (e.g., non-punctured or non-rate matched) DM-RS REs in example 610 and 620 to perform channel estimation at 510. In some aspects, the network node 502 may not use non-excluded (e.g., non-punctured or non-rate matched) DM-RS REs on non-CRS symbols (DM-RS REs that do not overlap with CRS REs in the time domain). In such aspects, the network node 502 may not use non-excluded (e.g., non-punctured or non-rate matched) DM-RS REs on OFDM symbol #1 in example 610 and 620 to perform channel estimation at 510. In such aspects, the network node 502 may use non-excluded (e.g., non-punctured or non-rate matched) DM-RS REs on OFDM symbol #2 in example 610 and 620 to perform channel estimation at 510.

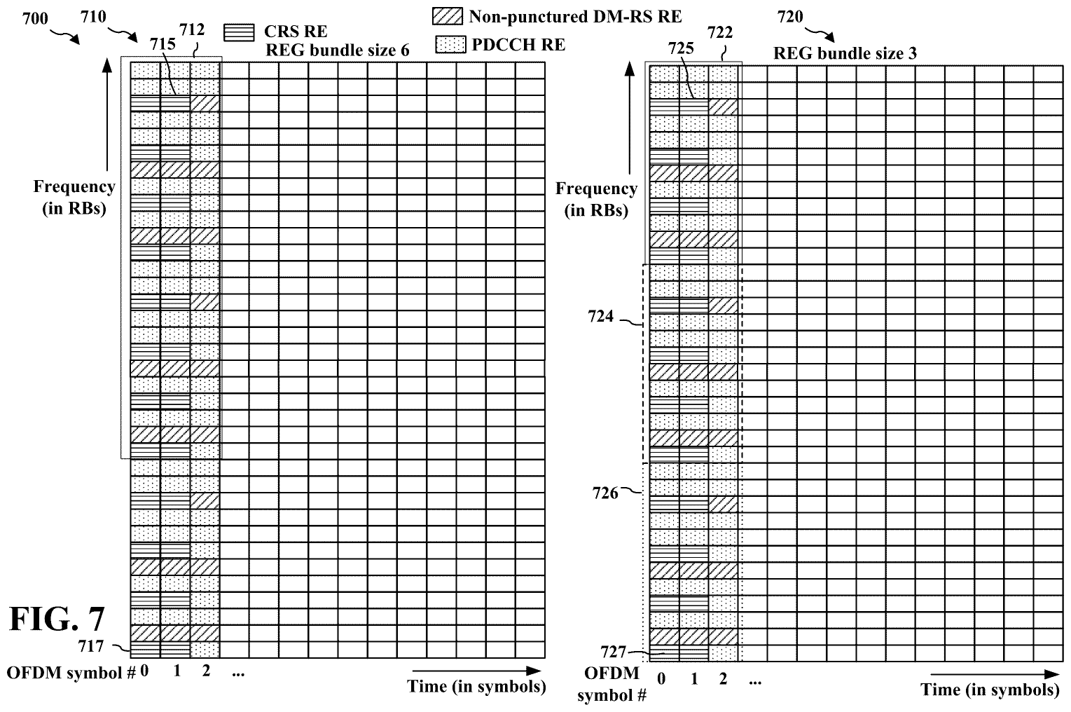

FIG. 7 is a diagram 700 illustrating example 710 and example 720 where DM-RS REs that collide with CRS REs are excluded (e.g., punctured or rate matched). For example, DM-RS REs configured by the PDCCH 508 may collide with CRS REs configured by the RRC communication 506. The DM-RS REs configured by the PDCCH 508 may be accordingly excluded (e.g., punctured or rate matched). As illustrated in FIG. 7, DM-RS REs that collide with CRS REs may be excluded (e.g., punctured or rate matched).

In some aspects, REs may be arranged in REG bundles of a REG bundle size. For example, in example 710, the REG bundle size of the REG bundle 712 may be six (e.g., based on two RB times three symbols). In example 720, the REG bundle size of the REG bundle 722, the REG bundle 724, and the REG bundle 726 may be three (e.g., based on one RB times three symbols). A REG bundle size may be based on a precoder granularity that a base station (e.g., the network node 504) may use for a UE (e.g., the network node 502). In some examples, each precoder may be associated with a different beam. In some aspects, REs in a same REG bundle may be associated with a same precoding. For example, the network node 504 may apply a same precoder for REs in the REG bundle 712. Similarly, the network node 504 may apply a first precoder for REs in the REG bundle 722, a second precoder for REs in the REG bundle 724, and a third precoder for REs in the REG bundle 726. When the network node 502 performs the channel estimation at 510, the network node 502 may average channel estimation (e.g., to obtain a more accurate channel estimation) based on DM-RSs in a same REG bundle because a same precoder is associated with the REG bundle. For example, the network node 502 may perform a channel estimation based on DM-RSs in the REG bundle 712 and average the channel estimations. The network node 502 may also perform channel estimation based on DM-RSs in the REG bundle 722 and average the channel estimations. The network node 502 may not average a first channel estimation based on DM-RSs in the REG bundle 722 and a second channel estimation based on DM-RSs in the REG bundle 724. Similarly, the network node 502 may not average a second channel estimation based on DM-RSs in the REG bundle 724 and a third channel estimation based on DM-RSs in the REG bundle 726.

In some aspects, each DM-RS in the REG bundle 712 and REG bundle 722 may be configured to be in a set of three in the frequency domain (e.g., three DM-RSs on different symbols in a same RB), but some DM-RS REs may collide with CRS REs and may be accordingly excluded (e.g., punctured or rate matched). For example, a DM-RS RE that collides with the CRS RE 715 may be excluded (e.g., punctured or rate matched) and a DM-RS RE that collides with the CRS RE 725 may be excluded (e.g., punctured or rate matched). In some aspects, PDCCH REs that collide with CRS REs may also be excluded (e.g., punctured or rate matched). For example, a PDCCH RE may collide with CRS RE 717 and may be excluded (e.g., punctured or rate matched). A PDCCH RE may collide with CRS RE 727 and may be excluded (e.g., punctured or rate matched).

In some aspects, the network node 502 may use non-excluded (e.g., non-punctured or non-rate matched) DM-RS REs on CRS symbols (DM-RS REs that overlap with CRS REs in the time domain). In such aspects, the network node 502 may use all of the illustrated non-excluded (e.g., non-punctured or non-rate matched) DM-RS REs in example 710 and 720 to perform channel estimation at 510. In some aspects, the network node 502 may not use non-excluded (e.g., non-punctured or non-rate matched) DM-RS REs on non-CRS symbols (DM-RS REs that do not overlap with CRS REs in the time domain). In such aspects, the network node 502 may not use non-excluded (e.g., non-punctured or non-rate matched) DM-RS REs on OFDM symbol #1 in example 710 and 720 to perform channel estimation at 510. In such aspects, the network node 502 may use non-excluded (e.g., non-punctured or non-rate matched) DM-RS REs on OFDM symbol #2 in example 710 and 720 to perform channel estimation at 510.

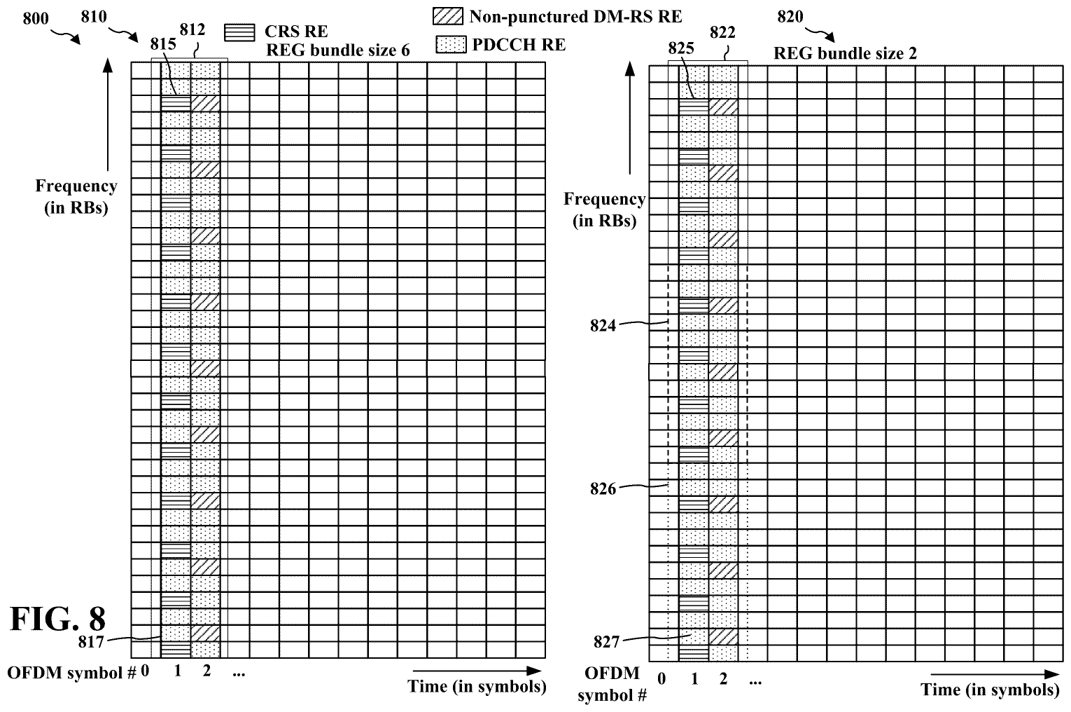

In some aspects, DM-RS REs that collide with CRS REs may be excluded (e.g., punctured or rate-matched) and non-excluded (e.g., non-punctured or non-rate matched) DM-RS REs on CRS symbols (DM-RS REs that overlap with CRS REs in the time domain) may be replaced by PDCCH REs. FIG. 8 is a diagram 800 illustrating example 810 and example 820 where DM-RS REs that collide with CRS REs are excluded (e.g., punctured or rate matched) and non-excluded (e.g., non-punctured or non-rate matched) DM-RS REs on CRS symbols (DM-RS REs that overlap with CRS REs in the time domain) may be replaced by PDCCH REs. In some aspects, REs may be arranged in REG bundles of a REG bundle size. For example, in example 810, the REG bundle size of the REG bundle 812 may be six (e.g., based on three RBs times 2 symbols). In example 820, the REG bundle size of the REG bundle 822, the REG bundle 824, and the REG bundle 826 may be two. A REG bundle size may be based on a precoder granularity that a base station (e.g., the network node 504) may use for a UE (e.g., the network node 502). In some examples, each precoder may be associated with a different beam. In some aspects, REs in a same REG bundle may be associated with a same precoding. For example, the network node 504 may apply a same precoder for REs in the REG bundle 812. Similarly, the network node 504 may apply a first precoder for REs in the REG bundle 822, a second precoder for REs in the REG bundle 824, and a third precoder for REs in the REG bundle 826. When the network node 502 performs the channel estimation at 510, the network node 502 may average channel estimation (e.g., to obtain a more accurate channel estimation) based on DM-RSs in a same REG bundle because a same precoder is associated with the REG bundle. For example, the network node 502 may perform channel estimation based on DM-RSs in the REG bundle 812 and average the channel estimations. The network node 502 may also perform channel estimation based on DM-RSs in the REG bundle 822 and average the channel estimations. The network node 502 may not average a first channel estimation based on DM-RSs in the REG bundle 822 and a second channel estimation based on DM-RSs in the REG bundle 824. Similarly, the network node 502 may not average a second channel estimation based on DM-RSs in the REG bundle 824 and a third channel estimation based on DM-RSs in the REG bundle 826.

In some aspects, each DM-RS in the REG bundle 812 and REG bundle 822 may be configured to be in pairs in the frequency domain (e.g., two DM-RSs on different symbols in a same RB) but some DM-RS REs may collide with CRS REs and may be accordingly excluded (e.g., punctured or rate matched). For example, a DM-RS RE that collides with the CRS RE 815 may be excluded (e.g., punctured or rate matched) and a DM-RS RE that collides with the CRS RE 825 may be excluded (e.g., punctured or rate matched).

In some aspects, DM-RS REs that collide with CRS REs are punctured and non-excluded (e.g., non-punctured or non-rate matched) DM-RS REs on CRS symbols (DM-RS REs that overlap with CRS REs in the time domain) may be replaced by PDCCH REs. For example, DM-RS RE on OFDM symbol #1 may be replaced by PDCCH REs. As one example, a DM-RS RE on OFDM #1 may be replaced by a PDCCH RE 817. As another example, a DM-RS RE on OFDM #1 may be replaced by a PDCCH RE 827. In some aspects, the network node 502 may use non-excluded (e.g., non-punctured or non-rate matched) DM-RS REs on OFDM symbol #2 in example 810 and 820 to perform channel estimation at 510.

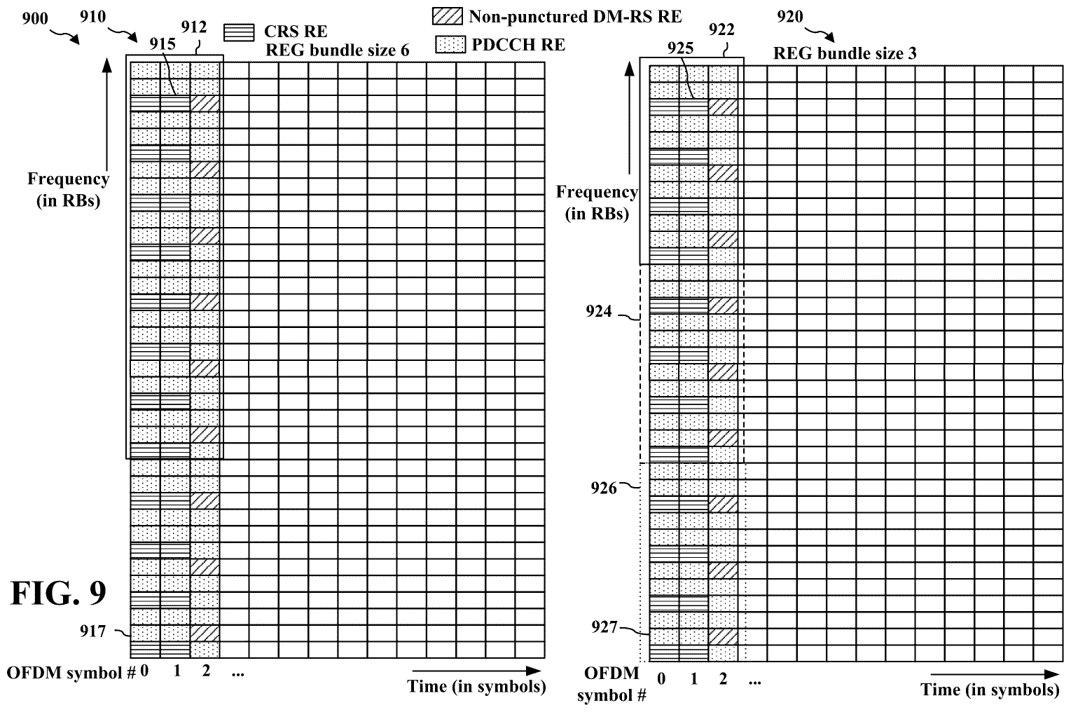

FIG. 9 is a diagram 900 illustrating example 910 and example 920 where DM-RS REs that collide with CRS REs are excluded (e.g., punctured or rate matched) and non-excluded (e.g., non-punctured or non-rate matched) DM-RS REs on CRS symbols (DM-RS REs that overlap with CRS REs in the time domain) may be replaced by PDCCH REs.

In some aspects, REs may be arranged in REG bundles of a REG bundle size. For example, in example 910, the REG bundle size of the REG bundle 912 may be six (e.g., based on three RBs times two symbols). In example 920, the REG bundle size of the REG bundle 922, the REG bundle 924, and the REG bundle 926 may be three. A REG bundle size may be based on a precoder granularity that a base station (e.g., the network node 504) may use for a UE (e.g., the network node 502). In some examples, each precoder may be associated with a different beam. In some aspects, REs in a same REG bundle may be associated with a same precoding. For example, the network node 504 may apply a same precoder for REs in the REG bundle 912. Similarly, the network node 504 may apply a first precoder for REs in the REG bundle 922, a second precoder for REs in the REG bundle 924, and a third precoder for REs in the REG bundle 926. When the network node 502 performs the channel estimation at 510, the network node 502 may average channel estimation (e.g., to obtain a more accurate channel estimation) based on DM-RSs in a same REG bundle because a same precoder is associated with the REG bundle. For example, the network node 502 may perform channel estimation based on DM-RSs in the REG bundle 912 and average the channel estimations. The network node 502 may also perform channel estimation based on DM-RSs in the REG bundle 922 and average the channel estimations. The network node 502 may not average a first channel estimation based on DM-RSs in the REG bundle 922 and a second channel estimation based on DM-RSs in the REG bundle 924. Similarly, the network node 502 may not average a second channel estimation based on DM-RSs in the REG bundle 924 and a third channel estimation based on DM-RSs in the REG bundle 926.

In some aspects, each DM-RS in the REG bundle 912 and REG bundle 922 may be configured to be in a set of three in the frequency domain (e.g., three DM-RSs on different symbols in a same RB) but some DM-RS REs may collide with CRS REs and may be accordingly excluded (e.g., punctured or rate matched). For example, a DM-RS RE that collides with the CRS RE 915 may be excluded (e.g., punctured or rate matched) and a DM-RS RE that collides with the CRS RE 925 may be excluded (e.g., punctured or rate matched).

In some aspects, DM-RS REs that collide with CRS REs are excluded (e.g., punctured or rate matched) and non-excluded (e.g., non-punctured or non-rate matched) DM-RS REs on CRS symbols (DM-RS REs that overlap with CRS REs in the time domain) may be replaced by PDCCH REs. For example, DM-RS RE on OFDM symbol #1 may be replaced by PDCCH REs. As one example, a DM-RS RE on OFDM #1 may be replaced by a PDCCH RE 917. As another example, a DM-RS RE on OFDM #1 may be replaced by a PDCCH RE 927. In some aspects, the network node 502 may use non-excluded (e.g., non-punctured or non-rate matched) DM-RS REs on OFDM symbol #2 in example 910 and 920 to perform channel estimation at 510.

In some aspects, puncturing DM-RS REs that collide with CRS REs may reduce the number of DMRS REs per channel estimation. Additionally, DM-RS REs on CRS symbols may correspond to an unequal-distant mapping. To improve performance of channel estimation, some aspects provided herein may provide a PDCCH (e.g., for PDCCH 508) that may support flexible precoder granularity.

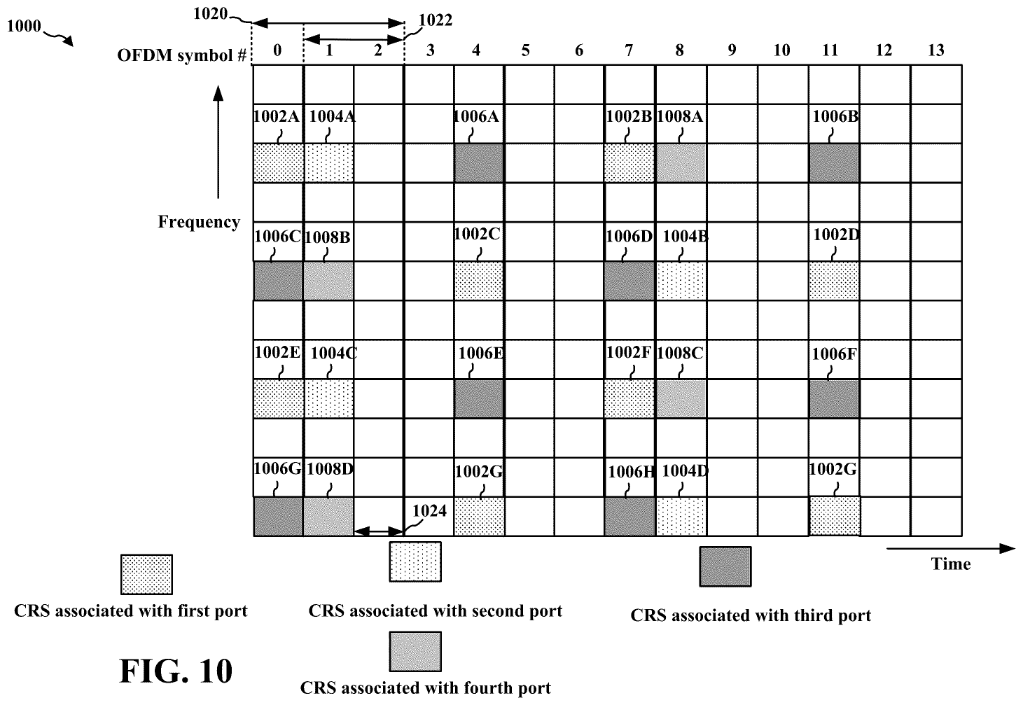

FIG. 10 is a diagram 1000 illustrating example 1-symbol CORESET and CORESET of two or more symbols. Similar to FIG. 4, in FIG. 10, each grid may represent an OFDM symbol. As one example, a PDCCH candidate spans 1-3 OFDM symbol(s) of a slot depending on parameters configured for the search space (such as a SearchSpace parameter) and a CORESET associated with the search space. As illustrated in FIG. 10, on a downlink cell, CRS symbols may be associated with different ports (e.g., downlink antenna ports), such as a first port, a second port, a third port, or a fourth port. As illustrated in FIG. 10, CRS REs 1002A, 1002B, 1002C, 1002D, 1002E, 1002F, and 1002G may be associated with a first port (such as port #0). The CRS REs 1004A, 1004B, 1004C, and 1004D may be associated with a second port (such as port #1). The CRS REs 1006A, 1006B, 1006C, 1006D, 1006E, 1006F, 1006G, and 1006H may be associated with a third port (such as port #2). The CRS REs 1008A, 1008B, 1008C, and 1008D may be associated with a fourth port (such as port #3). As illustrated in FIG. 10, the CRS REs may be on OFDM symbols #0-#1, #4 , #7-8, #11. The PDCCH 508 may be associated with a CORESET. In some aspects, for some UEs, PDCCH on symbol #2 may be enabled. In some aspects, for UEs not supporting CORESET of two or more symbols (such as 2-symbol or 3-symbol), type 0/0A/1/2 common search space (CSS) sets are monitored on symbol #2 using 1-symbol CORESET 1024. In some aspects, a type 0 CSS may be PDCCH common search space set configured by a parameter of common search space #0 (which may be a first CSS and may be represented by a searchSpaceZero parameter) in a master information block (represented by a MasterinformationBlock parameter) or by a search space in system information block type 1 (e.g., represented by a searchSpaceSIB1 parameter) in a PDCCH configuration (e.g., represented by a PDCCH-ConfigCommon parameter) for a DCI format with cyclic redundancy check (CRC) scrambled by a system information radio network temporary identifier (SI-RNTI) on a primary cell. In some aspects, a type 0A CSS may be a PDCCH common search space set configured by search space indicated by other system information (OSI) (e.g., represented by a searchSpace-OSI parameter) in a PDCCH configuration (e.g., represented by a PDCCH-ConfigCommon parameter) for a DCI format with CRC scrambled by a SI-RNTI on a primary cell. In some aspects, a type 1 CSS may be a PDCCH common search space set configured for a random access procedure (represented by a ra-SearchSpace parameter) in a PDCCH configuration (e.g., represented by a PDCCH-ConfigCommon parameter) for a DCI format with CRC scrambled by a random access radio network temporary identifier (RA-RNTI), or a temporary cell radio network temporary identifier (TC-RNTI) on a primary cell. In some aspects, a type 2 CSS may be a PDCCH common search space set configured for paging (e.g., represented by a pagingSearchSpace parameter) in a PDCCH configuration (e.g., represented by a PDCCH-ConfigCommon parameter) for a DCI format with CRC scrambled by a paging radio network temporary identifier (P-RNTI) on a primary cell. In some aspects, a type 3 CSS or UE-specific search space (USS) may also be monitored on a same symbol/CORESET. In some aspects, a type 3 CSS may be a PDCCH common search space set configured by a SearchSpace parameter in a PDCCH configuration. In some aspects, a USS may be a UE-specific search space monitored by a UE (e.g., the network node 502) in a connected mode.

In some aspects, some UEs may support CORESET of two or more symbols (such as 2-symbol or 3-symbol). In some aspects, for such UEs, CORESET of two or more symbols (such as 2-symbol CORESET 1022 or 3-symbol CORESET 1020) may be used for type 0/0A/1/2 CSS sets, a type 3 CSS set, and a USS set. The network, such as the network node 504, may duplicate the PDCCH transmissions for type 0/0A/1/2 CSS sets on a 1-symbol CORESET.

In some aspects, for such UEs, CORESET of two or more symbols (such as 2-symbol CORESET 1022 or 3-symbol CORESET 1020) may be used for a type 3 CSS set and a USS set while CORESET of 1-symbol may be used for type 0/0A/1/2 CSS sets. A UE (such as the network node 502) may blindly decode two partially overlapped CORESETs (e.g., 1-symbol CORESET and CORESET of two or more symbols).

In some aspects, for PDCCH associated with CORESET of two or more symbols, precoder granularity may be supported such that process gain of channel estimation is not degraded compared with 1-symbol CORESET. In some aspects, channel estimates may be reused for the CORESET of two or more symbols and the 1-symbol CORESET.

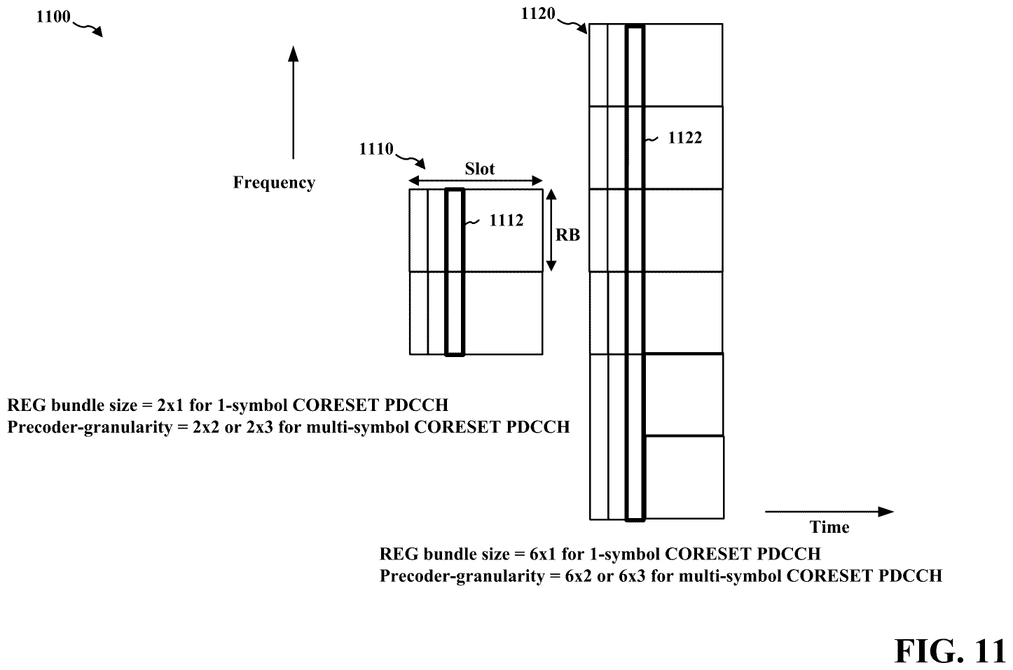

FIG. 11 is a diagram 1100 illustrating example precoder granularity for CORESET of two or more symbols. As illustrated in FIG. 11, as one example in a first REG bundle 1110 which may include REs for 1-symbol CORESET PDCCH and multi-symbol CORESET PDCCH (e.g., PDCCH with CORESET of two or more symbols), the REG bundle size may be defined to be 2×1 for 1-symbol CORESET PDCCH (e.g., based on size of REs in 1112) and a precoder granularity may be 2×N for multi-symbol CORESET PDCCH, N being equal to the number of the multi-symbols (e.g., 2×2 for 2-symbol CORESET PDCCH, 2×3 for 3-symbol CORESET PDCCH, and the like). In some aspects, within the first REG bundle 1110, a same precoder may be used for both 1-symbol COREESET PDCCH and multi-symbol CORESET PDCCH.

The precoder granularity may be different from 2×N for multi-symbol CORESET PDCCH. In some aspects, for a multi-symbol CORESET, REG-bundle may be based on a REG bundle for a multi-symbol CORESET format (e.g., 1×2 or 3×2 for 2-symbol CORESET, 1×3 or 2×3 for 3-symbol CORESET). In some aspects, precoder granularity may be based on the number of RBs of REG-bundle for a 1-symbol CORESET, e.g., 2 RBs or 6 RBs.

Similarly, in a REG bundle 1120 (e.g., a second REG bundle) which may include REs for 1-symbol COREESET PDCCH and multi-symbol CORESET PDCCH (e.g., PDCCH with CORESET of two or more symbols), the REG bundle size may be defined to be 6×1 for 1-symbol COREESET PDCCH (e.g., based on size of REs in 1122) and a precoder granularity may be 6×N for multi-symbol CORESET PDCCH, N being equal to the number of the multi-symbols (e.g., 6×2 for 2-symbol CORESET PDCCH, 6×3 for 3-symbol CORESET PDCCH, and the like). In some aspects, within the REG bundle 1120 (e.g., a first REG bundle), a same precoder is used for both 1-symbol COREESET PDCCH and multi-symbol CORESET PDCCH. In some aspects, a UE (such as the network node 502) configured with multi-symbol CORESET PDCCH may assume that a same precoder is used for the group of REGs in a same precoder granularity. In some aspects, for the multi-symbol CORESET PDCCH, REG bundle size may be the same as a 1-symbol CORESET PDCCH and the precoder granularity for the multi-symbol CORESET PDCCH may be larger than (e.g., N times) the REG bundle size. The control channel element (CCE) to REG mapping for the multi-symbol CORESET PDCCH and the 1-symbol CORESET PDCCH may be the same. In some aspects, for both interleaved and non-interleaved mapping, the UE (e.g., the network node 502) may assume the same precoding being used within a REG bundle if a higher-layer parameter representing precoder granularity (e.g., precoderGranularity parameter) equals a REG bundle size (e.g., represented by a sameAsREG-bundle parameter). In some aspects, the UE (e.g., the network node 502) may also assume the same precoding being used across the all resource-element groups within the set of contiguous resource blocks in the CORESET if the higher-layer parameter a higher-layer parameter representing precoder granularity (e.g., precoderGranularity parameter) equals to the value of a parameter representing all contiguous RBs (e.g., an allContiguousRBs parameter). In some aspects, the UE (e.g., the network node 502) may also have multi-symbol CORESET PDCCH enabled based on a semi-wideband CORESET parameter representing multi-symbol CORESET PDCCH.

In some aspects, for the multi-symbol CORESET PDCCH, REG bundle size may be N times the REG bundle size of a partially overlapping 1-symbol CORESET PDCCH. For example, the REG bundle size of the multi-symbol CORESET PDCCH associated with the REG bundle 1110 may be 2×N, N being equal to the number of the multi-symbols (e.g., 2×2 for 2-symbol CORESET PDCCH, 2×3 for 3-symbol CORESET PDCCH, and the like). As another example, the REG bundle size of the multi-symbol CORESET PDCCH associated with the REG bundle 1120 may be 6×N, N being equal to the number of the multi-symbols (e.g., 6×2 for 2-symbol CORESET PDCCH, 6×3 for 3-symbol CORESET PDCCH, and the like). In such aspects, the precoder granularity may be equal to the REG bundle size. In such aspects, for interleaved CCE to REG mapping, the interleaving unit may be larger than a CCE. In some aspects, as one example, REG bundle size L=12 or 18 may be enabled for 2-symbol and 3-symbol CORESET PDCCH.

In some aspects, a UE may assume that a same precoder is used for one REG bundle of a 1-symbol CORESET and one or more REG-bundles associated with multi-symbol CORESET if 1) the REG bundle size of the 1-symbol CORESET is equal to the number of RBs of the precoder granularity and 2) the 1-symbol CORESET and the one or more REG-bundles overlaps in the frequency domain.

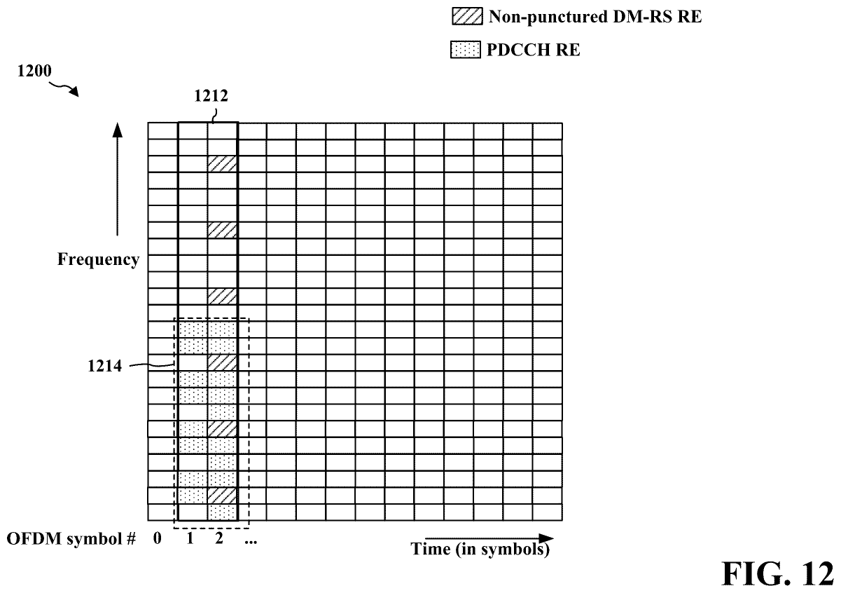

FIG. 12 is a diagram 1200 illustrating REG bundle 1214 and associated DM-RS being outside the REG bundle. As illustrated in FIG. 12, for a REG bundle 1214 associated with a precoder granularity 1212, there may be one or more DM-RS REs associated with the REG bundle 1214 while being outside the REG bundle 1214. In some aspects, the precoder granularity 1212 may include additional REG bundles. In some aspects, within the precoder granularity 1212, channel estimations based on different REG bundles in the precoder granularity 1212 may be averaged by a UE (e.g., the network node 502). A CORESET associated with the REG bundle 1214 may be a two-symbol CORESET and the REG bundle size may be 1×2.

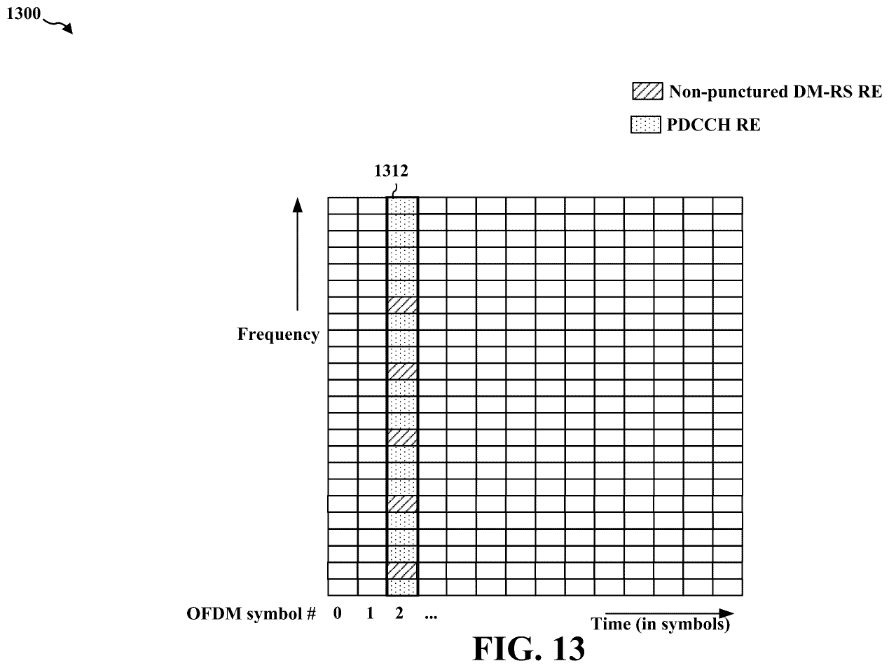

FIG. 13 is a diagram 1300 illustrating REG bundle and associated DM-RS. As illustrated in FIG. 13, a CORESET associated with the REG bundle 1312 may be a one-symbol CORESET and the REG bundle size may be 2×1. The REG bundle 1312 in FIG. 13 may be associated with a same precoder as the REG bundle 1214 in FIG. 12.

In some wireless communication systems, a maximum number of non-overlapped CCEs for PDCCH monitoring may be defined to limit or cap UE complexity for channel estimation using PDCCH DM-RS. Channel estimation may be per REG-bundle and a CCE may be a unit specified for channel estimation complexity. In some aspects, CCEs for PDCCH candidates are non-overlapped if they correspond to different CORESET indexes or different first symbols for the reception of the respective PDCCH candidates. In some aspects, a UE may count CCEs separately for PDCCH candidates associated with different CORESETs even if shared channel estimation for REG-bundles of PDCCH candidates in two partially-overlapped CORESETs is enabled, as illustrated in FIG. 13.

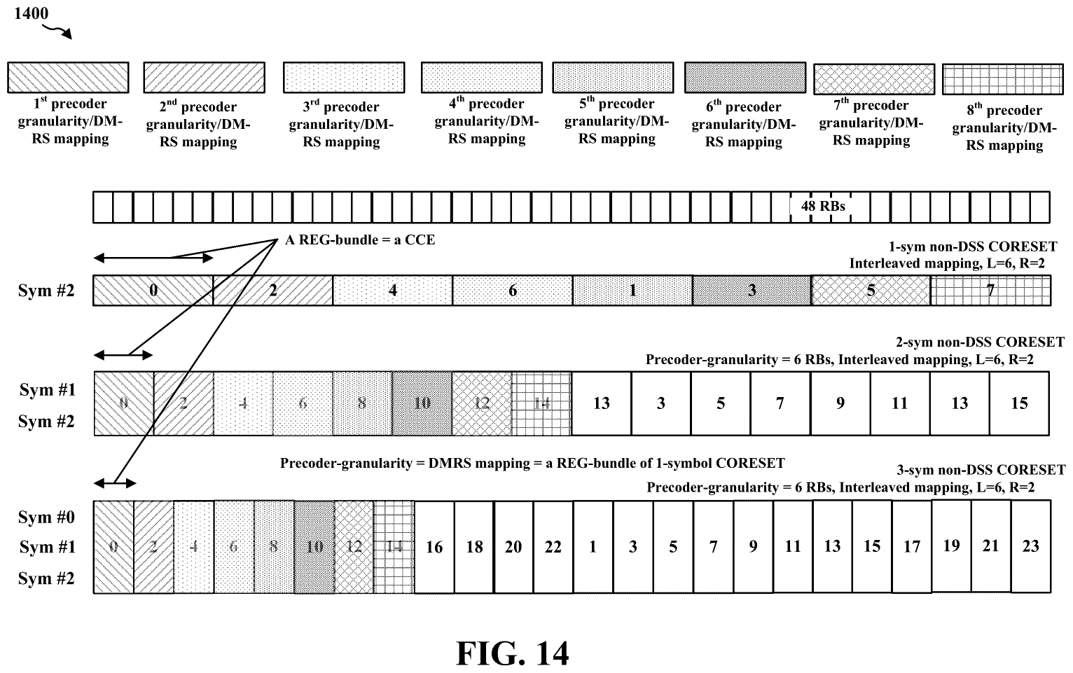

FIG. 14 is a diagram 1400 illustrating example CORESETs. As illustrated in FIG. 14, a UE may monitor PDCCH candidates on 1-symbol (1-sym), 2-symbol (2-sym), or 3-symbol (3-sym) non-DSS CORESETs on CCE #0. The UE may count a number of non-overlapped CCEs as 3. The DM-RS mapping and precoder size may be different for each of the non-overlapped CCEs and the UE may accordingly perform channel estimations for each of the non-overlapped CCEs.

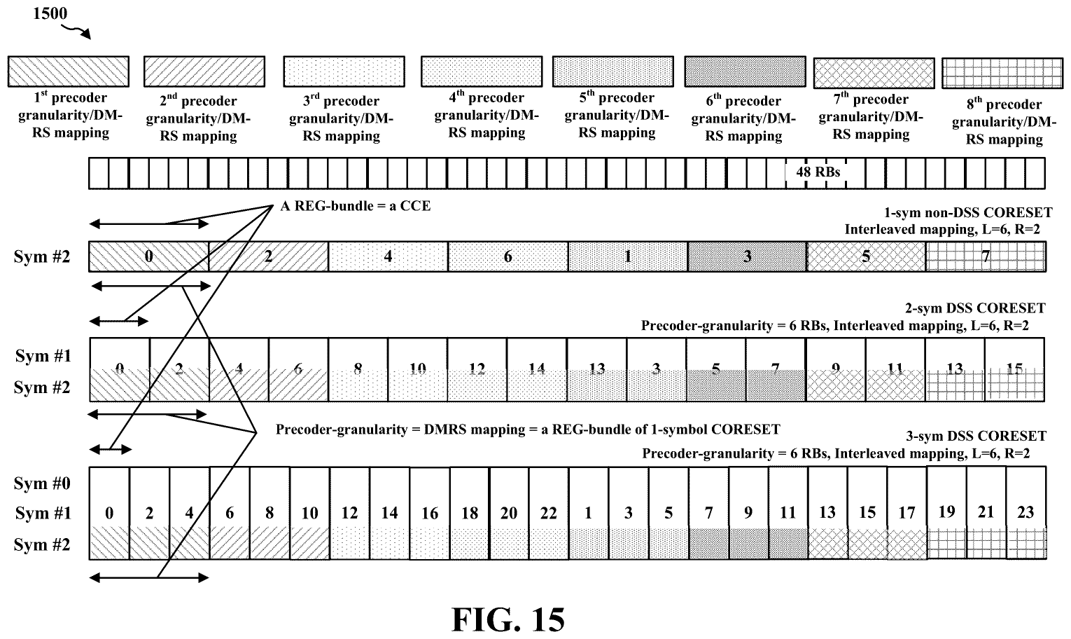

FIG. 15 is a diagram 1500 illustrating example CORESETs. As illustrated in FIG. 15, a UE may monitor PDCCH candidates on a 1-sym non-DSS CORESET and one or both of 2-sym and 3-sym non-DSS CORESETs on CCE #0. In some aspects, the UE may not perform channel estimation for the CCEs on the same/subset of RBs. For example, for CCEs with index #0 on all the CORESETs with a same DM-RS mapping and precoder, channel estimation for CCE #0 of a 1-sym non-DSS CORESET may be re-used to process CCE #0 of a 2-sym or 3-sym DSS CORESET.

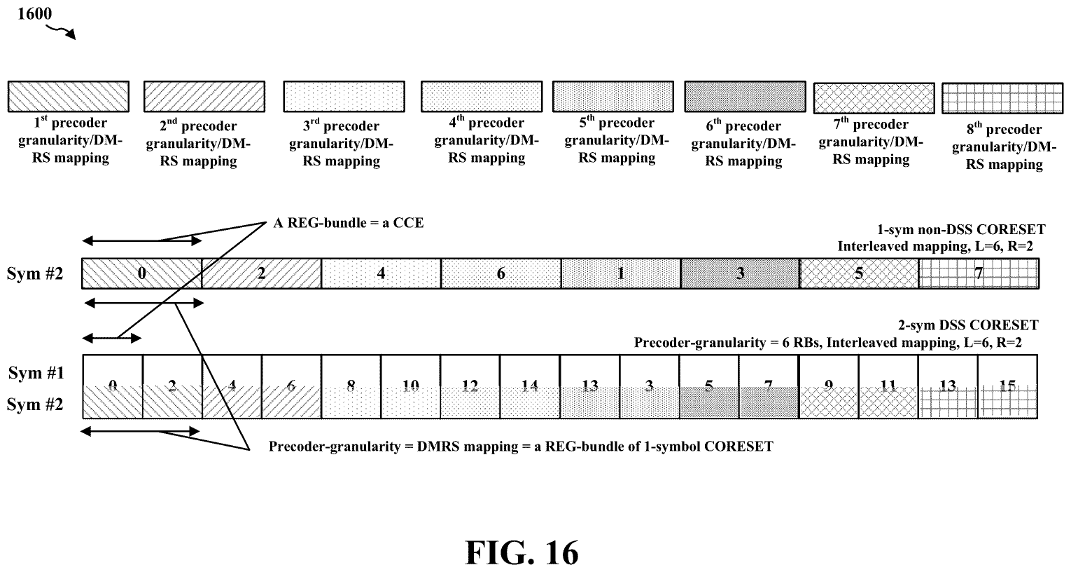

FIG. 16 is a diagram 1600 illustrating example CORESETs. In some aspects, CCE #0 of a 1-sym non-DSS CORESET and CCE #2 of the DSS CORESET may be counted as one non-overlapped CCE. In some aspects, CCE #0 of a 1-sym non-DSS CORESET and CCE #2 of the DSS CORESET may be counted as two non-overlapped CCEs. Whether to count CCE #0 of a 1-sym non-DSS CORESET and CCE #2 of the DSS CORESET as one non-overlapped CCE or two non-overlapped CCEs may be based on an RRC configuration or a UE capability. In some aspects, CCEs #0 and #2 of the DSS CORESET may be counted as one non-overlapped CCE. In some aspects, CCEs #0 and #2 of the DSS CORESET may be counted as two non-overlapped CCEs. Also, whether to count CCEs #0 and #2 of the DSS CORESET as one non-overlapped CCE or two non-overlapped CCEs may be based on an RRC configuration or a UE capability.

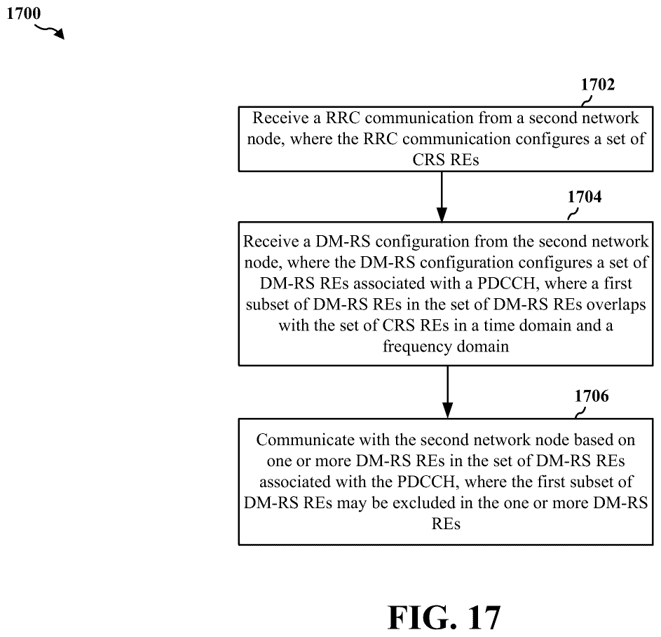

FIG. 17 is a flowchart 1700 of a method of wireless communication at a first network node. The first network node may be a UE (e.g., the UE 104, the network node 502, the apparatus 2004).

At 1702, the first network node may receive an RRC communication from a second network node. The RRC communication may configure a set of CRS REs. For example, the network node 502 may receive an RRC communication 506 from a second network node 504. In some aspects, 1702 may be performed by the PDCCH component 198.

At 1704, the first network node may receive a DM-RS configuration from the second network node. For example, the network node 502 may receive a DM-RS configuration associated with the PDCCH 508 from the second network node 504. In some aspects, 1704 may be performed by the PDCCH component 198. In some aspects, the DM-RS configuration may configure a set of DM-RS REs associated with a PDCCH.

At 1706, the first network node may communicate with the second network node based on one or more DM-RS REs in the set of DM-RS REs associated with the PDCCH. For example, the network node 502 may communicate (e.g., communication 512) with the second network node 504 based on one or more DM-RS REs in the set of DM-RS REs associated with the PDCCH 508. In some aspects, 1706 may be performed by the PDCCH component 198. In some aspects, the first subset of DM-RS REs may be excluded from the one or more DM-RS REs.

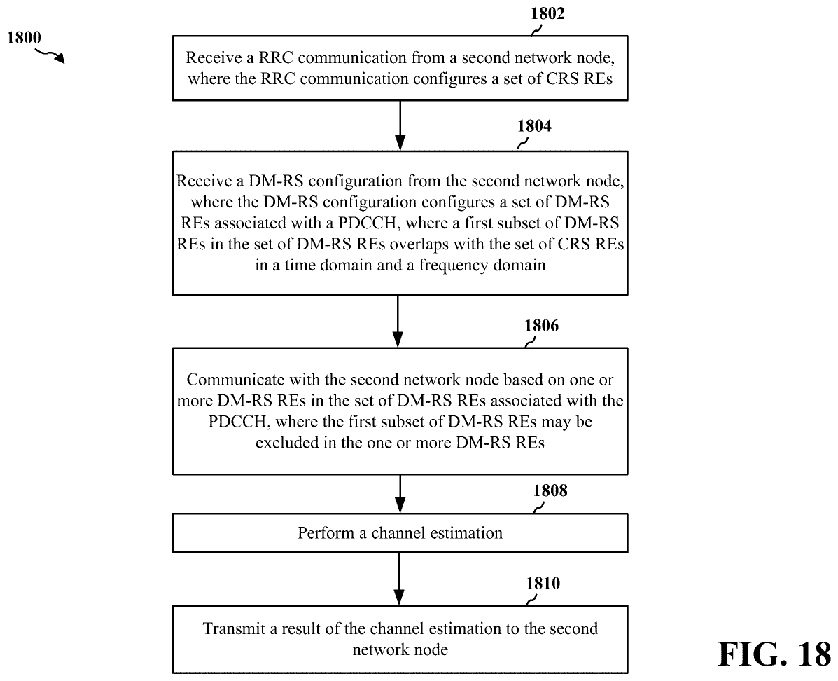

FIG. 18 is a flowchart 1800 of a method of wireless communication at a first network node. The first network node may be a UE (e.g., the UE 104, the network node 502, the apparatus 2004).

At 1802, the first network node may receive an RRC communication from a second network node. The RRC communication may configure a set of CRS REs. For example, the network node 502 may receive an RRC communication 506 from a second network node 504. In some aspects, 1802 may be performed by the PDCCH component 198.

At 1804, the first network node may receive a DM-RS configuration from the second network node. For example, the network node 502 may receive a DM-RS configuration associated with the PDCCH 508 from the second network node 504. In some aspects, 1804 may be performed by the PDCCH component 198. In some aspects, the DM-RS configuration may configure a set of DM-RS REs associated with a PDCCH. In some aspects, a first subset of DM-RS REs in the set of DM-RS REs may overlap with the set of CRS REs in a time domain and a frequency domain.

At 1806, the first network node may communicate with the second network node based on one or more DM-RS REs in the set of DM-RS REs associated with the PDCCH. For example, the network node 502 may communicate (e.g., communication 512) with the second network node 504 based on one or more DM-RS REs in the set of DM-RS REs associated with the PDCCH 508. In some aspects, 1806 may be performed by the PDCCH component 198. In some aspects, the first subset of DM-RS REs may be excluded from the one or more DM-RS REs. In some aspects, the first network node may refrain from using a second subset of DM-RS REs in the set of DM-RS REs, the second subset of DM-RS REs may overlap with the set of CRS REs in the time domain, and the one or more DM-RS REs exclude the second subset of DM-RS REs. In some aspects, a second subset of DM-RS REs in the set of DM-RS REs overlaps with the set of CRS REs in the time domain and may be replaced by one or more PDCCH REs associated with the PDCCH. In some aspects, the first subset of DM-RS REs may be punctured based on a first control resource set (CORESET) structure, and the first network node may monitor a type 0 common search space (CSS) set, a type 0A CSS set, a type 1 CSS set, or a type 2 CSS set associated with a second CORESET structure. A CORESET structure may refer to a 1-symbol CORESET structure or a multi-symbol CORESET structure. In some aspects, USS set may be configured at least for the first CORESET structure. In some aspects, the first CORESET structure may be based on two or more symbols and the second CORESET structure is based on one symbol. In some aspects, the two or more symbols may include X symbols, where X may be a positive integer, and where a precoder granularity supported by the first CORESET structure may be based on a bundle size of a REG bundle in the frequency domain associated with the first CORESET structure. In some aspects, the two or more symbols may include X symbols, where X may be a positive integer, where a precoder granularity supported by the first CORESET structure may be based on a bundle size of a REG bundle in the frequency domain associated with the first CORESET structure, and where the precoder granularity is based on X. In some aspects, a non-overlapped CCE count for a first CCE associated with a first CORESET structure associated with the PDCCH and a second CCE associated with a second CORESET structure associated with the PDCCH is one or two based on a capability associated with the UE or a RRC configuration.

In some aspects, the first subset of DM-RS REs may be punctured based on a first CORESET structure. The first network node may monitor a type 0 CSS set, a type 0A CSS set, a type 1 CSS set, or a type 2 CSS set associated with the first CORESET structure. In some aspects, the first CORESET structure may be based on two or more symbols. In some aspects, the two or more symbols may include X symbols, where X may be a positive integer, and where a precoder granularity supported by the first CORESET structure may be based on a bundle size of a REG bundle associated with the first CORESET structure. In some aspects, the two or more symbols may include X symbols, where X may be a positive integer, where a precoder granularity supported by the first CORESET structure may be based on a bundle size of a REG bundle associated with the first CORESET structure, and where the precoder granularity is based on X.

In some aspects, the first subset of DM-RS REs may be excluded (e.g., punctured or rate matched) based on a first CORESET structure. In some aspects, the first network node may also monitor a type 0 CSS set, a type 0A CSS set, a type 1 CSS set, or a type 2 CSS set associated with a second CORESET structure or monitor a type 3 CSS set or a type 3 USS set associated with the first CORESET structure. In some aspects, the first CORESET structure may be based on two or more symbols that overlaps with a CRS symbol associated with the set of CRS REs and the second CORESET structure may be based on one symbol and do not overlap with the CRS symbol associated with the set of CRS REs, and where the first CORESET structure and the second CORESET structure overlaps on one or more symbols that do not overlap with the CRS symbol associated with the set of CRS REs. In some aspects, the two or more symbols may include X symbols, where X may be a positive integer, and where a precoder granularity supported by the first CORESET structure may be based on a bundle size of a REG bundle associated with the first CORESET structure. In some aspects, the two or more symbols may include X symbols, where X may be a positive integer, where a precoder granularity supported by the first CORESET structure may be based on a bundle size of REG bundle associated with the first CORESET structure, and where the precoder granularity is based on X. In some aspects, the set of DM-RS REs may be associated with a single REG bundle. In some aspects, the set of DM-RS REs may be associated with two or more REG bundles. In some aspects, each of the two or more REG bundles may be associated with a same precoder granularity. In some aspects, a precoder associated with the same precoder granularity may be associated with two or more CCEs. In some aspects, each of the two or more REG bundles may be associated with a same precoder. In some aspects, a bundle size associated with the two or more REG bundles may be equal to a number of RBs of a precoder granularity of the same precoder, and each of the two or more REG bundles may overlap in the frequency domain.

At 1808, the first network node may perform channel estimation. For example, the network node 502 may perform channel estimation at 510. In some aspects, 1808 may be performed by the PDCCH component 198. In some aspects, the first network node may perform a channel estimation based on a third subset of DM-RS REs in the set of DM-RS REs. The third subset of DM-RS REs may not overlap with the set of CRS REs in the time domain. In some aspects, the first network node may perform a channel estimation based on a second subset of DM-RS REs in the set of DM-RS REs. In some aspects, the second subset of DM-RS REs may overlap with the set of CRS REs in the time domain, and the second subset of DM-RS REs may be non-punctured and non-rate matched and does not collide with the set of CRS REs. In some aspects, the first network node may perform a channel estimation based on a third subset of DM-RS REs in the set of DM-RS REs, where the third subset of DM-RS REs may not overlap with the set of CRS REs in the time domain.

At 1810, the first network node may transmit a result of the channel estimation to the second network node. For example, the network node 502 may transmit a result of the channel estimation to the second network node 504 in communication 512. In some aspects, 1810 may be performed by the PDCCH component 198.

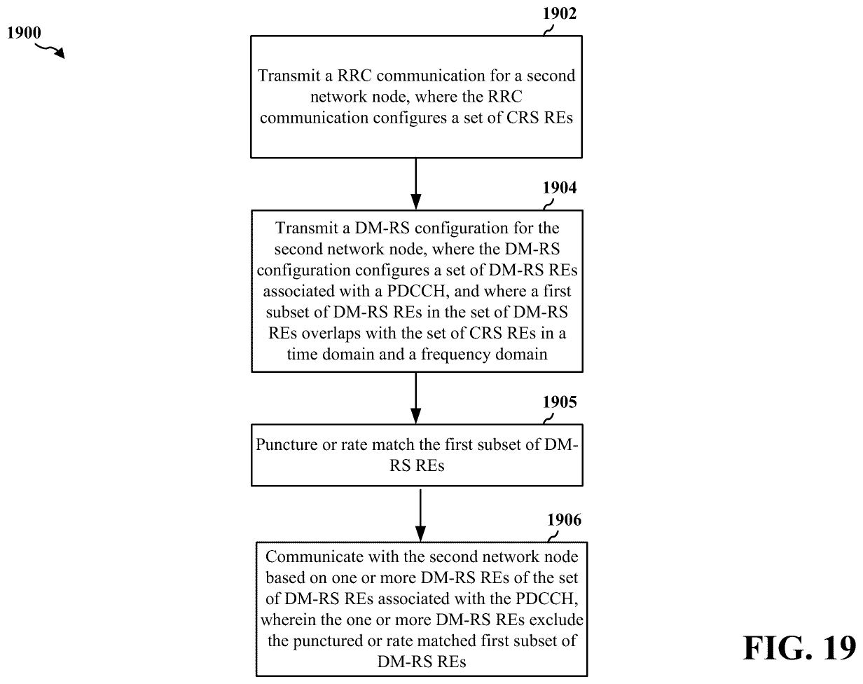

FIG. 19 is a flowchart 1900 of a method of wireless communication at a first network node. The first network node may be a network entity (e.g., the base station 102, the network node 504, the network entity 2002, the network entity 2102, the network entity 2260).

At 1902, the first network node may transmit an RRC communication for a second network node. In some aspects, the RRC communication may configure a set of CRS REs. For example, the network node 504 may transmit an RRC communication 506 for a second network node 502. In some aspects, 1902 may be performed by the PDCCH component 199.

At 1904, the first network node may transmit a DM-RS configuration for the second network node. For example, the network node 504 may transmit a DM-RS configuration associated with the PDCCH 508 for the second network node 502. In some aspects, 1904 may be performed by the PDCCH component 199. In some aspects, the DM-RS configuration may configure a set of DM-RS REs associated with a PDCCH. In some aspects, a first subset of DM-RS REs in the set of DM-RS REs may overlap with the set of CRS REs in a time domain and a frequency domain. In some aspects, the set of DM-RS REs may be associated with a single REG bundle. In some aspects, the set of DM-RS REs may be associated with two or more REG bundles. In some aspects, each of the two or more REG bundles may be associated with a same precoder granularity.

At 1905, the first network node may puncture or rate match the first subset of DM-RS REs. In some aspects, 1905 may be performed by the PDCCH component 199. For example, the network node 504 may puncture or rate match the first subset of DM-RS REs.

At 1906, the first network node may communicate with the second network node based on one or more DM-RS REs of the set of DM-RS REs associated with the PDCCH. The one or more DM-RS REs may exclude the punctured or rate matched first subset of DM-RS REs. For example, the network node 504 may communicate (e.g., communication 512) with the second network node based on one or more DM-RS REs of the set of DM-RS REs associated with the PDCCH 508. In some aspects, 1906 may be performed by the PDCCH component 199.

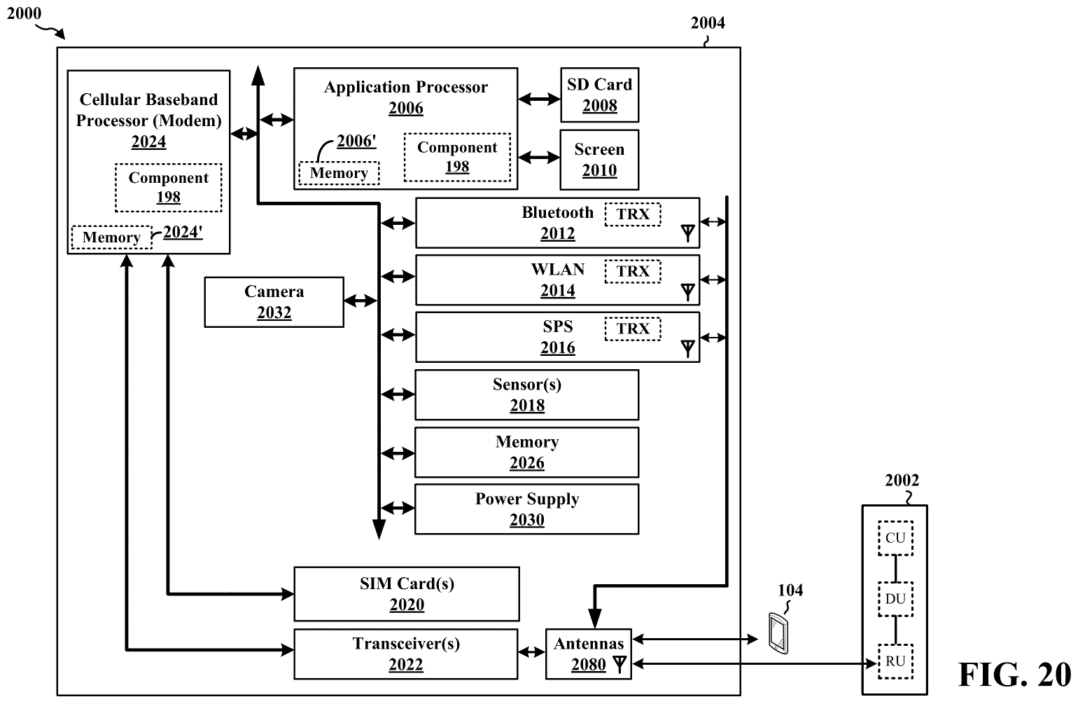

FIG. 20 is a diagram 2000 illustrating an example of a hardware implementation for an apparatus 2004. The apparatus 2004 may be a UE, a component of a UE, or may implement UE functionality. In some aspects, the apparatus 1704 may include a cellular baseband processor 2024 (also referred to as a modem) coupled to one or more transceivers 2022 (e.g., cellular RF transceiver). The cellular baseband processor 2024 may include on-chip memory 2024′. In some aspects, the apparatus 2004 may further include one or more subscriber identity modules (SIM) cards 2020 and an application processor 2006 coupled to a secure digital (SD) card 2008 and a screen 2010. The application processor 2006 may include on-chip memory 2006′. In some aspects, the apparatus 2004 may further include a Bluetooth module 2012, a WLAN module 2014, an SPS module 2016 (e.g., GNSS module), one or more sensor modules 2018 (e.g., barometric pressure sensor/altimeter; motion sensor such as inertial management unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 2026, a power supply 2030, and/or a camera 2032. The Bluetooth module 2012, the WLAN module 2014, and the SPS module 2016 may include an on-chip transceiver (TRX) (or in some cases, just a receiver (RX)). The Bluetooth module 2012, the WLAN module 2014, and the SPS module 2016 may include their own dedicated antennas and/or utilize the antennas 2080 for communication. The cellular baseband processor 2024 communicates through the transceiver(s) 2022 via one or more antennas 2080 with the UE 104 and/or with an RU associated with a network entity 2002. The cellular baseband processor 2024 and the application processor 2006 may each include a computer-readable medium/memory 2024′, 2006′, respectively. The additional memory modules 2026 may also be considered a computer-readable medium/memory. Each computer-readable medium/memory 2024′, 2006′, 2026 may be non-transitory. The cellular baseband processor 2024 and the application processor 2006 are each responsible for general processing, including the execution of software stored on the computer-readable medium/memory. The software, when executed by the cellular baseband processor 2024/application processor 2006, causes the cellular baseband processor 2024/application processor 2006 to perform the various functions described herein. The computer-readable medium/memory may also be used for storing data that is manipulated by the cellular baseband processor 2024/application processor 2006 when executing software. The cellular baseband processor 2024/application processor 2006 may be a component of the UE 350 and may include the memory 360 and/or at least one of the TX processor 368, the RX processor 356, and the controller/processor 359. In one configuration, the apparatus 2004 may be a processor chip (modem and/or application) and include just the cellular baseband processor 2024 and/or the application processor 2006, and in another configuration, the apparatus 2004 may be the entire UE (e.g., see 350 of FIG. 3) and include the additional modules of the apparatus 2004.

As disclosed herein, the PDCCH component 198 may be configured to receive a radio resource control (RRC) communication from a second network node, where the RRC communication configures a set of cell-specific reference signal (CRS) resource elements (REs). In some aspects, the PDCCH component 198 may be further configured to receive a demodulation reference signal (DM-RS) configuration from the second network node, where the DM-RS configuration configures a set of DM-RS REs associated with a physical downlink control channel (PDCCH), and where a first subset of DM-RS REs in the set of DM-RS REs overlaps with the set of CRS REs in a time domain and a frequency domain. In some aspects, the PDCCH component 198 may be further configured to communicate with the second network node based on one or more DM-RS REs in the set of DM-RS REs associated with the PDCCH, where the first subset of DM-RS REs is excluded from the one or more DM-RS REs. The PDCCH component 198 may be within the cellular baseband processor 2024, the application processor 2006, or both the cellular baseband processor 2024 and the application processor 2006. The PDCCH component 198 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 2004 may include a variety of components configured for various functions. In one configuration, the apparatus 2004, and in particular the cellular baseband processor 2024 and/or the application processor 2006, includes means for receiving an RRC communication from a second network node, where the RRC communication configures a set of CRS REs. In some aspects, the apparatus 2004 may further include means for receiving a DM-RS configuration from the second network node, where the DM-RS configuration configures a set of DM-RS REs associated with a PDCCH, where a first subset of DM-RS REs in the set of DM-RS REs overlaps with the set of CRS REs in a time domain and a frequency domain. In some aspects, the apparatus 2004 may further include means for communicating with the second network node based on one or more DM-RS REs in the set of DM-RS REs associated with the PDCCH, where the first subset of DM-RS REs is excluded from the one or more DM-RS REs. In some aspects, the apparatus 2004 may further include means for refraining from using a second subset of DM-RS REs in the set of DM-RS REs, where the second subset of DM-RS REs overlaps with the set of CRS REs in the time domain. In some aspects, the apparatus 2004 may further include means for performing a channel estimation based on a third subset of DM-RS REs in the set of DM-RS REs, where the third subset of DM-RS REs does not overlap with the set of CRS REs in the time domain. In some aspects, the apparatus 2004 may further include means for performing a channel estimation based on a second subset of DM-RS REs in the set of DM-RS REs, where the second subset of DM-RS REs overlaps with the set of CRS REs in the time domain, where the second subset of DM-RS REs is non-punctured or non-rate matched, where the second subset of DM-RS REs does not collide with the set of CRS REs, and where the one or more DM-RS REs includes the second subset of DM-RS REs. In some aspects, the apparatus 2004 may further include means for performing a channel estimation based on a third subset of DM-RS REs in the set of DM-RS REs, where the third subset of DM-RS REs does not overlap with the set of CRS REs in the time domain. In some aspects, the apparatus 2004 may further include means for monitoring a type 0 common search space (CSS) set, a type 0A CSS set, a type 1 CSS set, or a type 2 CSS set associated with a second CORESET structure. In some aspects, the apparatus 2004 may further include means for monitoring a type 0 common search space (CSS) set, a type 0A CSS set, a type 1 CSS set, or a type 2 CSS set associated with the first CORESET structure. In some aspects, the apparatus 2004 may further include means for monitoring a type 0 common search space (CSS) set, a type 0A CSS set, a type 1 CSS set, or a type 2 CSS set associated with a second CORESET structure; or monitoring a type 3 CSS set or a type 3 UE-specific search space (USS) set associated with the first CORESET structure. In some aspects, the apparatus 2004 may further include means for performing a channel estimation based on a second subset of DM-RS REs in the set of DM-RS REs. In some aspects, the apparatus 2004 may further include means for transmitting a result of the channel estimation to the second network node.

The means may be the PDCCH component 198 of the apparatus 2004 configured to perform the functions recited by the means. As described herein, the apparatus 2004 may include the TX processor 368, the RX processor 356, and the controller/processor 359. As such, in one configuration, the means may be the TX processor 368, the RX processor 356, and/or the controller/processor 359 configured to perform the functions recited by the means.

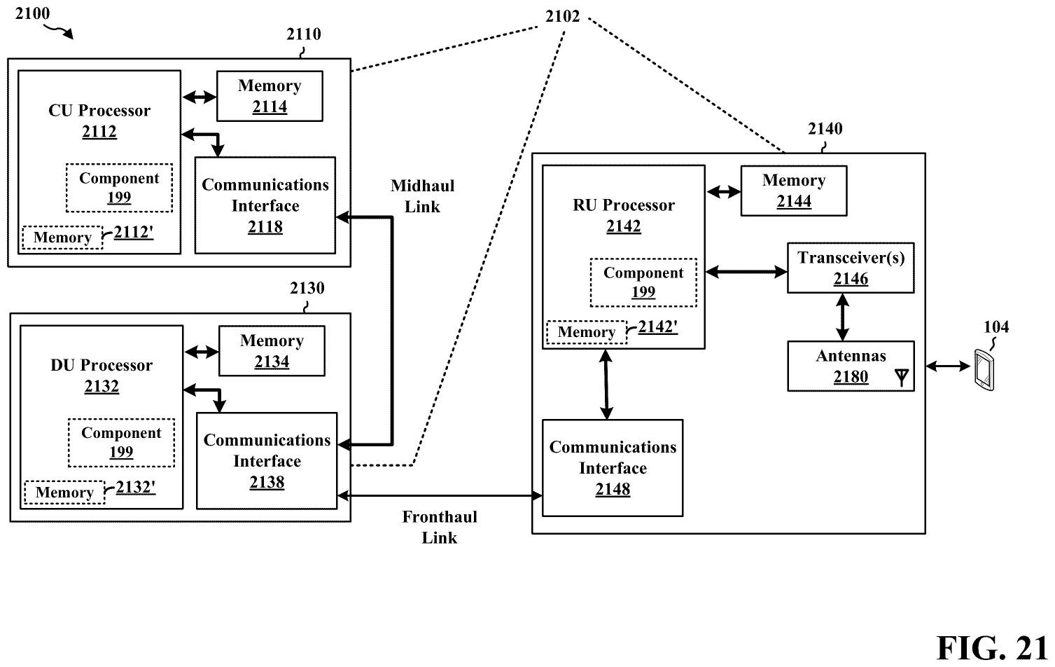

FIG. 21 is a diagram 2100 illustrating an example of a hardware implementation for a network entity 2102. The network entity 2102 may be a BS, a component of a BS, or may implement BS functionality. The network entity 2102 may include at least one of a CU 2110, a DU 2130, or an RU 2140. For example, depending on the layer functionality handled by the PDCCH component 199, the network entity 2102 may include the CU 2110; both the CU 2110 and the DU 2130; each of the CU 2110, the DU 2130, and the RU 2140; the DU 2130; both the DU 2130 and the RU 2140; or the RU 2140. The CU 2110 may include a CU processor 2112. The CU processor 2112 may include on-chip memory 2112′. In some aspects, the CU 2110 may further include additional memory modules 2114 and a communications interface 2118. The CU 2110 communicates with the DU 2130 through a midhaul link, such as an F1 interface. The DU 2130 may include a DU processor 2132. The DU processor 2132 may include on-chip memory 2132′. In some aspects, the DU 2130 may further include additional memory modules 2134 and a communications interface 2138. The DU 2130 communicates with the RU 2140 through a fronthaul link. The RU 2140 may include an RU processor 2142. The RU processor 2142 may include on-chip memory 2142′. In some aspects, the RU 2140 may further include additional memory modules 2144, one or more transceivers 2146, antennas 2180, and a communications interface 2148. The RU 2140 communicates with the UE 104. The on-chip memory 2112′, 2132′, 2142′ and the additional memory modules 2114, 2134, 2144 may each be considered a computer-readable medium/memory. Each computer-readable medium/memory may be non-transitory. Each of the processors 2112, 2132, 2142 is responsible for general processing, including the execution of software stored on the computer-readable medium/memory. The software, when executed by the corresponding processor(s) causes the processor(s) to perform the various functions described herein. The computer-readable medium/memory may also be used for storing data that is manipulated by the processor(s) when executing software.

As discussed herein, the PDCCH component 199 may be configured to transmit an RRC communication for a second network node, where the RRC communication configures a set of CRS REs. In some aspects, the PDCCH component 199 may be further configured to transmit a DM-RS configuration for the second network node, where the DM-RS configuration configures a set of DM-RS REs associated with a PDCCH, and where a first subset of DM-RS REs in the set of DM-RS REs overlaps with the set of CRS REs in a time domain and a frequency domain. In some aspects, the PDCCH component 199 may be further configured to puncture or rate match the first subset of DM-RS REs. In some aspects, the PDCCH component 199 may be further configured to communicate with the second network node based on one or more DM-RS REs of the set of DM-RS REs associated with the PDCCH, where the one or more DM-RS REs exclude the punctured or rate matched first subset of DM-RS REs. The PDCCH component 199 may be within one or more processors of one or more of the CU 2110, DU 2130, and the RU 2140. The PDCCH component 199 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 2102 may include a variety of components configured for various functions. In one configuration, the network entity 2102 includes means for transmitting an RRC communication for a second network node, where the RRC communication configures a set of CRS REs. In some aspects, the network entity 2102 may further include means for transmitting a DM-RS configuration for the second network node, where the DM-RS configuration configures a set of DM-RS REs associated with a PDCCH, and where a first subset of DM-RS REs in the set of DM-RS REs overlaps with the set of CRS REs in a time domain and a frequency domain. In some aspects, the network entity 2102 may further include means for puncturing or rate matching the first subset of DM-RS REs. In some aspects, the network entity 2102 may further include means for communicating with the second network node based on one or more DM-RS REs of the set of DM-RS REs associated with the PDCCH, where the one or more DM-RS REs exclude the punctured or rate matched first subset of DM-RS REs. The means may be the PDCCH component 199 of the network entity 2102 configured to perform the functions recited by the means. As disclosed herein, the network entity 2102 may include the TX processor 316, the RX processor 370, and the controller/processor 375. As such, in one configuration, the means may be the TX processor 316, the RX processor 370, and/or the controller/processor 375 configured to perform the functions recited by the means.

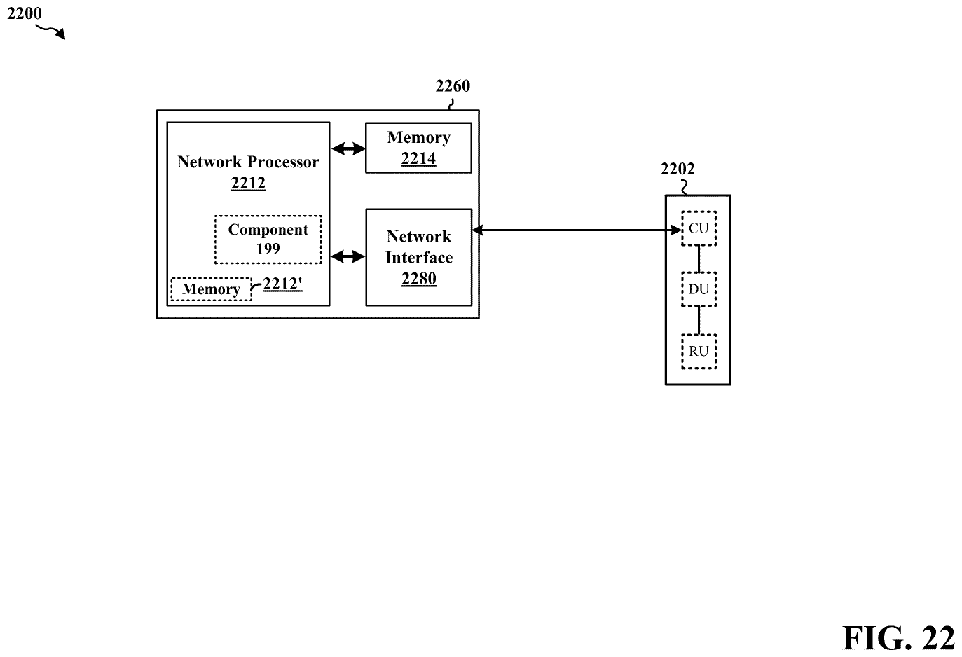

FIG. 22 is a diagram 2200 illustrating an example of a hardware implementation for a network entity 2260. In one example, the network entity 2260 may be within the core network 120. The network entity 2260 may include a network processor 2212. The network processor 2212 may include on-chip memory 2212′. In some aspects, the network entity 2260 may further include additional memory modules 2214. The network entity 2260 communicates via the network interface 2280 directly (e.g., backhaul link) or indirectly (e.g., through a RIC) with the CU 2202. The on-chip memory 2212′ and the additional memory modules 2214 may each be considered a computer-readable medium/memory. Each computer-readable medium/memory may be non-transitory. The processor 2212 is responsible for general processing, including the execution of software stored on the computer-readable medium/memory. The software, when executed by the corresponding processor(s) causes the processor(s) to perform the various functions described herein. The computer-readable medium/memory may also be used for storing data that is manipulated by the processor(s) when executing software.

As disclosed herein, the PDCCH component 199 may be configured to transmit an RRC communication for a second network node, where the RRC communication configures a set of CRS REs. In some aspects, the PDCCH component 199 may be further configured to transmit a DM-RS configuration for the second network node, where the DM-RS configuration configures a set of DM-RS REs associated with a PDCCH, and where a first subset of DM-RS REs in the set of DM-RS REs overlaps with the set of CRS REs in a time domain and a frequency domain. In some aspects, the PDCCH component 199 may be further configured to puncture or rate match the first subset of DM-RS REs. In some aspects, the PDCCH component 199 may be further configured to communicate with the second network node based on one or more DM-RS REs of the set of DM-RS REs associated with the PDCCH, where the one or more DM-RS REs exclude the punctured or rate matched first subset of DM-RS REs. The PDCCH component 199 may be within the processor 2212. The PDCCH component 199 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 2260 may include a variety of components configured for various functions. In one configuration, the network entity 2260 includes means for transmitting an RRC communication for a second network node, where the RRC communication configures a set of CRS REs. The network entity 2260 may further include means for transmitting a DM-RS configuration for the second network node, where the DM-RS configuration configures a set of DM-RS REs associated with a PDCCH, and where a first subset of DM-RS REs in the set of DM-RS REs overlaps with the set of CRS REs in a time domain and a frequency domain. The network entity 2260 may further include means for puncturing or rate matching the first subset of DM-RS REs. The network entity 2260 may further include means for communicating with the second network node based on one or more DM-RS REs of the set of DM-RS REs associated with the PDCCH, where the one or more DM-RS REs exclude the punctured or rate matched first subset of DM-RS REs. The means may be the PDCCH component 199 of the network entity 2260 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. If a first apparatus receives data from or transmits data to a second apparatus, the data may be received/transmitted directly between the first and second apparatuses, or indirectly between the first and second apparatuses through a set of apparatuses. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method for wireless communication at a first network node, including: receiving a radio resource control (RRC) communication from a second network node, where the RRC communication configures a set of cell-specific reference signal (CRS) resource elements (REs); receiving a demodulation reference signal (DM-RS) configuration from the second network node, where the DM-RS configuration configures a set of DM-RS REs associated with a physical downlink control channel (PDCCH), where a first subset of DM-RS REs in the set of DM-RS REs overlaps with the set of CRS REs in a time domain and a frequency domain; and communicating with the second network node based on one or more DM-RS REs in the set of DM-RS REs associated with the PDCCH, where the first subset of DM-RS REs is excluded from the one or more DM-RS REs.

Aspect 2 is the method of aspect 1, further including: refraining from using a second subset of DM-RS REs in the set of DM-RS REs, where the second subset of DM-RS REs overlaps with the set of CRS REs in the time domain, and where the one or more DM-RS REs exclude the second subset of DM-RS REs; and performing a channel estimation based on a third subset of DM-RS REs in the set of DM-RS REs, where the third subset of DM-RS REs does not overlap with the set of CRS REs in the time domain.

Aspect 3 is the method of aspect 1, further including: performing a channel estimation based on a second subset of DM-RS REs in the set of DM-RS REs, where the second subset of DM-RS REs overlaps with the set of CRS REs in the time domain, and where the second subset of DM-RS REs is non-punctured or non-rate matched, where the second subset of DM-RS REs does not collide with the set of CRS REs, and where the one or more DM-RS REs includes the second subset of DM-RS REs.

Aspect 4 is the method of aspect 1, where a second subset of DM-RS REs in the set of DM-RS REs overlaps with the set of CRS REs in the time domain and is replaced by one or more PDCCH REs associated with the PDCCH, and further including: performing a channel estimation based on a third subset of DM-RS REs in the set of DM-RS REs, where the third subset of DM-RS REs does not overlap with the set of CRS REs in the time domain.

Aspect 5 is the method of any of aspects 1-4, where the first subset of DM-RS REs is punctured or rate matched based on a first control resource set (CORESET) structure, and further including: monitoring a type 0 common search space (CSS) set, a type 0A CSS set, a type 1 CSS set, or a type 2 CSS set associated with a second CORESET structure.

Aspect 6 is the method of any of aspects 1-5, where the first CORESET structure is based on two or more symbols and the second CORESET structure is based on one symbol.

Aspect 7 is the method of any of aspects 1-6, where the two or more symbols include X symbols, where X is a positive integer, and where a precoder granularity supported by the first CORESET structure is based on a bundle size of a resource element group (REG) bundle in the frequency domain associated with the first CORESET structure.

Aspect 8 is the method of any of aspects 1-6, where the two or more symbols include X symbols, where X is a positive integer, where a precoder granularity supported by the first CORESET structure is based on a bundle size of a resource element group (REG) bundle in the frequency domain associated with the first CORESET structure, and where the precoder granularity is based on X.

Aspect 9 is the method of any of aspects 1-8, where the first subset of DM-RS REs is punctured or rate matched based on a first control resource set (CORESET) structure, and further including: monitoring a type 0 common search space (CSS) set, a type 0A CSS set, a type 1 CSS set, or a type 2 CSS set associated with the first CORESET structure.

Aspect 10 is the method of any of aspects 1-9, where the first CORESET structure is based on two or more symbols.

Aspect 11 is the method of any of aspects 1-10, where the two or more symbols include X symbols, where X is a positive integer, and where a precoder granularity supported by the first CORESET structure is based on a bundle size of a resource element group (REG) bundle associated with the first CORESET structure.

Aspect 12 is the method of any of aspects 1-10, where the two or more symbols include X symbols, where X is a positive integer, where a precoder granularity supported by the first CORESET structure is based on a bundle size of a resource element group (REG) bundle associated with the first CORESET structure, and where the precoder granularity is based on X.

Aspect 13 is the method of any of aspects 1-12, where the first subset of DM-RS REs is punctured or rate matched based on a first control resource set (CORESET) structure, and further including: monitoring a type 0 common search space (CSS) set, a type 0A CSS set, a type 1 CSS set, or a type 2 CSS set associated with a second CORESET structure; or monitoring a type 3 CSS set or a type 3 UE-specific search space (USS) set associated with the first CORESET structure.

Aspect 14 is the method of any of aspects 1-13, where the first CORESET structure is based on two or more symbols that overlaps with a CRS symbol associated with the set of CRS REs and the second CORESET structure is based on one symbol and do not overlap with the CRS symbol associated with the set of CRS REs, and where the first CORESET structure and the second CORESET structure overlaps on one or more symbols that do not overlap with the CRS symbol associated with the set of CRS REs.

Aspect 15 is the method of any of aspects 1-14, where the two or more symbols include X symbols, where X is a positive integer, and where a precoder granularity supported by the first CORESET structure is based on a bundle size of a resource element group (REG) bundle associated with the first CORESET structure.

Aspect 16 is the method of any of aspects 1-14, where the two or more symbols include X symbols, where X is a positive integer, where a precoder granularity supported by the first CORESET structure is based on a bundle size of a resource element group (REG) bundle associated with the first CORESET structure, and where the precoder granularity is based on X.

Aspect 17 is the method of any of aspects 1-16, further including: performing a channel estimation based on a second subset of DM-RS REs in the set of DM-RS REs; and transmitting a result of the channel estimation to the second network node.

Aspect 18 is the method of any of aspects 1-17, where a non-overlapped control channel element (CCE) count for a first CCE associated with a first control resource set (CORESET) structure for the PDCCH and a second CCE associated with a second CORESET structure for the PDCCH is based on an RRC configuration or a capability associated with the first network node.

Aspect 19 is the method of any of aspects 1-18, where the set of DM-RS REs is associated with two or more resource element group (REG) bundles.

Aspect 20 is the method of any of aspects 1-19, where each of the two or more REG bundles is associated with a same precoder granularity.

Aspect 21 is the method of any of aspects 1-20, where a precoder associated with the same precoder granularity is associated with two or more control channel elements (CCEs).

Aspect 22 is the method of any of aspects 1-19, where each of the two or more REG bundles is associated with a same precoder.

Aspect 23 is the method of any of aspects 1-22, where a bundle size associated with the two or more REG bundles is equal to a number of resource blocks (RBs) of a precoder granularity of the same precoder, and where each of the two or more REG bundles overlaps in the frequency domain.

Aspect 24 is the method of any of aspects 1-23, where the first network node corresponds to a user equipment (UE) or at least one component of the UE, and the second network node corresponds to a base station or one or more components of the base station.

Aspect 25 is a method for wireless communication at a first network node, including: transmitting a radio resource control (RRC) communication for a second network node, where the RRC communication configures a set of cell-specific reference signal (CRS) resource elements (REs); transmitting a demodulation reference signal (DM-RS) configuration for the second network node, where the DM-RS configuration configures a set of DM-RS REs associated with a physical downlink control channel (PDCCH), where a first subset of DM-RS REs in the set of DM-RS REs overlaps with the set of CRS REs in a time domain and a frequency domain; puncturing or rate matching the first subset of DM-RS REs; and communicating with the second network node based on one or more DM-RS REs of the set of DM-RS REs associated with the PDCCH, where the one or more DM-RS REs exclude the punctured or rate matched first subset of DM-RS REs.

Aspect 26 is the method of aspect 25, where the set of DM-RS REs is associated with a single resource element group (REG) bundle.

Aspect 27 is the method of aspect 25, where the set of DM-RS REs is associated with two or more resource element group (REG) bundles.

Aspect 28 is the method of aspect 27, where each of the two or more REG bundles is associated with a same precoder granularity.

Aspect 29 is an apparatus for wireless communication at a network entity including a memory and at least one processor coupled to the memory and, based at least in part on information stored in the memory, configured to perform a method in accordance with any of aspects 1-24. The apparatus may include at least one of a transceiver or an antenna coupled to the at least one processor.

Aspect 30 is an apparatus for wireless communications, including means for performing a method in accordance with any of aspects 1-24.

Aspect 31 is a non-transitory computer-readable medium including instructions that, when executed by an apparatus, cause the apparatus to perform a method in accordance with any of aspects 1-24.

Aspect 32 is an apparatus for wireless communication at a network entity including a memory and at least one processor coupled to the memory and, based at least in part on information stored in the memory, configured to perform a method in accordance with any of aspects 25-28. The apparatus may include at least one of a transceiver or an antenna coupled to the at least one processor.

Aspect 33 is an apparatus for wireless communications, including means for performing a method in accordance with any of aspects 25-28.

Aspect 34 is a non-transitory computer-readable medium including instructions that, when executed by an apparatus, cause the apparatus to perform a method in accordance with any of aspects 25-28.

What is claimed is:

1. A first network node for wireless communication, comprising:
a memory; and
at least one processor coupled to the memory, wherein the at least one processor is configured to:
receive a radio resource control (RRC) communication from a second network node, wherein the RRC communication configures a set of cell-specific reference signal (CRS) resource elements (REs);
receive a demodulation reference signal (DM-RS) configuration from the second network node, wherein the DM-RS configuration configures a set of DM-RS REs associated with a physical downlink control channel (PDCCH), wherein a first subset of DM-RS REs in the set of DM-RS REs overlaps with the set of CRS REs in a time domain and a frequency domain; and
communicate with the second network node based on one or more DM-RS REs in the set of DM-RS REs associated with the PDCCH, wherein the first subset of DM-RS REs is excluded from the one or more DM-RS REs.

2. The first network node of claim 1, wherein the at least one processor is configured to:
refrain from using a second subset of DM-RS REs in the set of DM-RS REs, wherein the second subset of DM-RS REs overlaps with the set of CRS REs in the time domain, and wherein the one or more DM-RS REs exclude the second subset of DM-RS REs; and
perform a channel estimation based on a third subset of DM-RS REs in the set of DM-RS REs, wherein the third subset of DM-RS REs does not overlap with the set of CRS REs in the time domain.

3. The first network node of claim 1, wherein the at least one processor is configured to:
perform a channel estimation based on a second subset of DM-RS REs in the set of DM-RS REs, wherein the second subset of DM-RS REs overlaps with the set of CRS REs in the time domain, wherein the second subset of DM-RS REs is non-punctured or non-rate matched, wherein the second subset of DM-RS REs does not collide with the set of CRS REs, and wherein the one or more DM-RS REs includes the second subset of DM-RS REs.

4. The first network node of claim 1, wherein a second subset of DM-RS REs in the set of DM-RS REs overlaps with the set of CRS REs in the time domain and is replaced by one or more PDCCH REs associated with the PDCCH, and wherein the at least one processor is configured to:
perform a channel estimation based on a third subset of DM-RS REs in the set of DM-RS REs, wherein the third subset of DM-RS REs does not overlap with the set of CRS REs in the time domain.

5. The first network node of claim 1, wherein the first subset of DM-RS REs is punctured or rate matched based on a first control resource set (CORESET) structure, and wherein the at least one processor is configured to:
monitor a type 0 common search space (CSS) set, a type 0A CSS set, a type 1 CSS set, or a type 2 CSS set associated with a second CORESET structure.

6. The first network node of claim 5, wherein the first CORESET structure is based on two or more symbols and the second CORESET structure is based on one symbol.

7. The first network node of claim 6, wherein the two or more symbols include X symbols, where X is a positive integer, and wherein a precoder granularity supported by the first CORESET structure is based on a bundle size of a resource element group (REG) bundle in the frequency domain associated with the first CORESET structure.

8. The first network node of claim 6, wherein the two or more symbols include X symbols, where X is a positive integer, wherein a precoder granularity supported by the first CORESET structure is based on a bundle size of a resource element group (REG) bundle in the frequency domain associated with the first CORESET structure, and wherein the precoder granularity is based on X.

9. The first network node of claim 1, wherein the first subset of DM-RS REs is punctured or rate matched based on a first control resource set (CORESET) structure, and wherein the at least one processor is configured to:
monitor a type 0 common search space (CSS) set, a type 0A CSS set, a type 1 CSS set, or a type 2 CSS set associated with the first CORESET structure.

10. The first network node of claim 9, wherein the first CORESET structure is based on two or more symbols.

11. The first network node of claim 10, wherein the two or more symbols include X symbols, where X is a positive integer, and wherein a precoder granularity supported by the first CORESET structure is based on a bundle size of a resource element group (REG) bundle associated with the first CORESET structure.

12. The first network node of claim 10, wherein the two or more symbols include X symbols, where X is a positive integer, and wherein a precoder granularity supported by the first CORESET structure is based on a bundle size of a resource element group (REG) bundle associated with the first CORESET structure, and wherein the precoder granularity is based on X.

13. The first network node of claim 1, wherein the first subset of DM-RS REs is punctured or rate matched based on a first control resource set (CORESET) structure, and wherein the at least one processor is configured to:
monitor a type 0 common search space (CSS) set, a type 0A CSS set, a type 1 CSS set, or a type 2 CSS set associated with a second CORESET structure; or
monitor a type 3 CSS set or a type 3 UE-specific search space (USS) set associated with the first CORESET structure.

14. The first network node of claim 13, wherein the first CORESET structure is based on two or more symbols that overlaps with a CRS symbol associated with the set of CRS REs and the second CORESET structure is based on one symbol and do not overlap with the CRS symbol associated with the set of CRS REs, and wherein the first CORESET structure and the second CORESET structure overlaps on one or more symbols that do not overlap with the CRS symbol associated with the set of CRS REs.

15. The first network node of claim 14, wherein the two or more symbols include X symbols, where X is a positive integer, and wherein a precoder granularity supported by the first CORESET structure is based on a bundle size of a resource element group (REG) bundle associated with the first CORESET structure.

16. The first network node of claim 14, wherein the two or more symbols include X symbols, where X is a positive integer, wherein a precoder granularity supported by the first CORESET structure is based on a bundle size of a resource element group (REG) bundle associated with the first CORESET structure, and wherein the precoder granularity is based on X.

17. The first network node of claim 1, wherein the at least one processor is configured to:
perform a channel estimation based on a second subset of DM-RS REs in the set of DM-RS REs; and
transmit a result of the channel estimation to the second network node.

18. The first network node of claim 1, wherein a non-overlapped control channel element (CCE) count for a first CCE associated with a first control resource set (CORESET) structure for the PDCCH and a second CCE associated with a second CORESET structure for the PDCCH is based on an RRC configuration or a capability associated with the first network node.

19. The first network node of claim 1, wherein the set of DM-RS REs is associated with two or more resource element group (REG) bundles.

20. The first network node of claim 19, wherein each of the two or more REG bundles is associated with a same precoder granularity.

21. The first network node of claim 20, wherein a precoder associated with the same precoder granularity is associated with two or more control channel elements (CCEs).

22. The first network node of claim 19, wherein each of the two or more REG bundles is associated with a same precoder.

23. The first network node of claim 22, wherein a bundle size associated with the two or more REG bundles is equal to a number of resource blocks (RB s) of a precoder granularity of the same precoder, and wherein each of the two or more REG bundles overlaps in the frequency domain.

24. The first network node of claim 1, wherein the first network node corresponds to a user equipment (UE) or at least one component of the UE, and the second network node corresponds to a base station or one or more components of the base station.

25. A first network node for wireless communication, comprising:
memory; and
at least one processor coupled to the memory, wherein the at least one processor is configured to:
transmit a radio resource control (RRC) communication for a second network node, wherein the RRC communication configures a set of cell-specific reference signal (CRS) resource elements (REs);
transmit a demodulation reference signal (DM-RS) configuration for the second network node, wherein the DM-RS configuration configures a set of DM-RS REs associated with a physical downlink control channel (PDCCH), wherein a first subset of DM-RS REs in the set of DM-RS REs overlaps with the set of CRS REs in a time domain and a frequency domain;
puncture or rate match the first subset of DM-RS REs; and
communicate with the second network node based on one or more DM-RS REs of the set of DM-RS REs associated with the PDCCH, wherein the one or more DM-RS REs exclude the punctured or rate matched first subset of DM-RS REs.

26. The first network node of claim 25, wherein the set of DM-RS REs is associated with a single resource element group (REG) bundle.

27. The first network node of claim 25, wherein the set of DM-RS REs is associated with two or more resource element group (REG) bundles.

28. The first network node of claim 27, wherein each of the two or more REG bundles is associated with a same precoder granularity.

29. A method for wireless communication at a first network node, comprising:
receiving a radio resource control (RRC) communication from a second network node, wherein the RRC communication configures a set of cell-specific reference signal (CRS) resource elements (REs);
receiving a demodulation reference signal (DM-RS) configuration from the second network node, wherein the DM-RS configuration configures a set of DM-RS REs associated with a physical downlink control channel (PDCCH), wherein a first subset of DM-RS REs in the set of DM-RS REs overlaps with the set of CRS REs in a time domain and a frequency domain; and
communicating with the second network node based on one or more DM-RS REs in the set of DM-RS REs associated with the PDCCH, wherein the first subset of DM-RS REs is excluded from the one or more DM-RS REs.

30. A method for wireless communication at a first network node, comprising:
transmitting a radio resource control (RRC) communication for a second network node, wherein the RRC communication configures a set of cell-specific reference signal (CRS) resource elements (REs);
transmitting a demodulation reference signal (DM-RS) configuration for the second network node, wherein the DM-RS configuration configures a set of DM-RS REs associated with a physical downlink control channel (PDCCH), wherein a first subset of DM-RS REs in the set of DM-RS REs overlaps with the set of CRS REs in a time domain and a frequency domain;
puncturing or rate matching the first subset of DM-RS REs; and
communicating with the second network node based on one or more DM-RS REs of the set of DM-RS REs associated with the PDCCH, wherein the one or more DM-RS REs exclude the punctured or rate matched first subset of DM-RS REs.
